(19) United States
(12) Patent Application Publication
(10) Pub. No.: US 2026/0100864 A1
(43) Pub. Date: Apr. 9, 2026

(54) ESTIMATING ORTHOGONAL FREQUENCY DIVISION MULTIPLEXING CHANNELS USING FREQUENCY MODULATED CONTINUOUS WAVEFORMS

(71) Applicant: QUALCOMM Incorporated, San Diego, CA (US)

(72) Inventors: Kangqi LIU, San Diego, CA (US); Jing JIANG, San Diego, CA (US); Jing DAI, Beijing (CN); Weimin DUAN, San Diego, CA (US); Roberto RIMINI, San Diego, CA (US); Seyedkianoush HOSSEINI, San Diego, CA (US)

(21) Appl. No.: 19/115,656

(22) PCT Filed: Dec. 5, 2022
(86) PCT No.: PCT/CN2022/136488

§ 371 Date: Mar. 26, 2025

(51) Int. Cl. H04L 25/02; H04L 5/00; H04L 27/00; H04L 27/26

(52) U.S. Cl. CPC H04L 25/0202; H04L 5/0053; H04L 27/0014; H04L 27/2649; H04L 2027/0091

(57) ABSTRACT

Methods, systems, and devices for wireless communication are described. A first wireless device may receive, from a second wireless device, a first frequency modulated continuous waveform (FMCW) signal via an orthogonal frequency division multiplexing (OFDM) channel. The first wireless device may generate a second FMCW signal based on a set of FMCW parameters associated with the first FMCW signal. The first wireless device may combine the first and second FMCW signals and filter the combined FMCW signal. The first wireless device may sample the combined and filtered FMCW signal in a time domain. The first wireless device may estimate the frequency domain OFDM channel based on sampling the combined and filtered FMCW signal. The first and second wireless devices may communicate OFDM signals via the OFDM channel based on the estimation of the frequency domain OFDM channel.

### CROSS REFERENCE

The present application is a 371 national phase filing of International PCT Application No. PCT/CN2022/136488 by LIU et al., entitled “ESTIMATING ORTHOGONAL FREQUENCY DIVISION MULTIPLEXING CHANNELS USING FREQUENCY MODULATED CONTINUOUS WAVEFORMS,” filed Dec. 5, 2022, which is assigned to the assignee hereof, and which is expressly incorporated by reference in its entirety herein.

### FIELD OF TECHNOLOGY

The following relates to wireless communication, including estimating orthogonal frequency division multiplexing (OFDM) channels using frequency modulated continuous waveforms (FMCWs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some systems, a receiving device, such as a UE, a network entity, or both, may estimate an orthogonal frequency division multiplexing (OFDM) channel based on one or more received OFDM signals. The receiving device may receive the OFDM signals in analog form, convert the analog OFDM signals to digital form, and transform the digital OFDM signals to frequency domain signals. The receiving device may perform the OFDM channel estimation in the frequency domain based on the frequency domain signals.

### SUMMARY

The described techniques relate to improved methods, systems, devices, and apparatuses that support estimating orthogonal frequency division multiplexing (OFDM) channels using frequency modulated continuous waveforms (FMCWs). For example, the described techniques provide for a wireless device to receive an FMCW signal via an OFDM channel and estimate the frequency domain OFDM channel using time-domain signal processing based on the FMCW signal. To perform the FMCW-based OFDM channel estimation techniques described herein, a first wireless device may receive a first FMCW signal from a second wireless device via an OFDM channel. The first wireless device may generate a second FMCW signal (e.g., a local FMCW signal) at the first wireless device based on one or more FMCW parameters associated with the first FMCW signal. The first wireless device may combine the first and second FMCW signals and filter the combined FMCW signal in a time domain. The first wireless device may sample (e.g., using an analog-to-digital converter (ADC)) the combined and filtered FMCW signal using a sampling rate that is based on one or more parameters of the OFDM channel. The first wireless device may estimate a value of each subband of multiple subbands across a frequency domain of the OFDM channel based on the sampling. The receiving device may thereby estimate a frequency domain OFDM channel using time domain signal processing and a relatively low sampling rate. In some examples, the first and second wireless devices may exchange one or more capability messages, control messages, or both to facilitate the FMCW-based OFDM channel estimation.

A method for wireless communication at a first wireless device is described. The method may include receiving a first FMCW signal via an OFDM channel, generating a second FMCW signal based on a set of FMCW parameters that are associated with the first FMCW signal, and estimating the OFDM channel based on samples of a combined FMCW signal in a time domain, the combined FMCW signal including a combination of the first FMCW signal and the second FMCW signal.

An apparatus for wireless communication is described. The apparatus may include a processor, memory coupled with the processor, and instructions stored in the memory. The instructions may be executable by the processor to cause the apparatus to receive a first FMCW signal via an OFDM channel, generate a second FMCW signal based on a set of FMCW parameters that are associated with the first FMCW signal, and estimate the OFDM channel based on samples of a combined FMCW signal in a time domain, the combined FMCW signal including a combination of the first FMCW signal and the second FMCW signal.

Another apparatus for wireless communication at a first wireless device is described. The apparatus may include means for receiving a first FMCW signal via an OFDM channel, means for generating a second FMCW signal based on a set of FMCW parameters that are associated with the first FMCW signal, and means for estimating the OFDM channel based on samples of a combined FMCW signal in a time domain, the combined FMCW signal including a combination of the first FMCW signal and the second FMCW signal.

A non-transitory computer-readable medium storing code for wireless communication at a first wireless device is described. The code may include instructions executable by a processor to receive a first FMCW signal via an OFDM channel, generate a second FMCW signal based on a set of FMCW parameters that are associated with the first FMCW signal, and estimate the OFDM channel based on samples of a combined FMCW signal in a time domain, the combined FMCW signal including a combination of the first FMCW signal and the second FMCW signal.

In some examples of the method, apparatuses, and non-transitory computer-readable medium described herein, estimating the OFDM channel may include operations, features, means, or instructions for filtering the combined FMCW signal and sampling, after the filtering, the combined FMCW signal in the time domain using a sampling rate that may be based on a subband frequency range of the OFDM channel, where the estimating includes estimating a respective value of the OFDM channel for each subband of a set of multiple subbands in a frequency domain of the OFDM channel based on the sampling.

Some examples of the method, apparatuses, and non-transitory computer-readable medium described herein may further include operations, features, means, or instructions for receiving one or more OFDM signals time division multiplexed with the first FMCW signal within the OFDM channel.

Some examples of the method, apparatuses, and non-transitory computer-readable medium described herein may further include operations, features, means, or instructions for transmitting a capability message that indicates the first wireless device may be capable of estimating the OFDM channel using time domain FMCW signals, where the first wireless device includes a user equipment (UE).

Some examples of the method, apparatuses, and non-transitory computer-readable medium described herein may further include operations, features, means, or instructions for receiving a capability message that indicates a second wireless device may be capable of transmitting FMCW signals for OFDM channel estimation, where the first wireless device includes a network entity.

Some examples of the method, apparatuses, and non-transitory computer-readable medium described herein may further include operations, features, means, or instructions for receiving a control message that indicates whether one or more symbols of the OFDM channel may be allocated for FMCW signals, where the first FMCW signal may be received within a symbol of the set of one or more symbols that may be indicated as allocated for the FMCW signals, and where the first wireless device includes a UE.

Some examples of the method, apparatuses, and non-transitory computer-readable medium described herein may further include operations, features, means, or instructions for transmitting a control message that indicates whether one or more symbols of the OFDM channel may be allocated for FMCW signals or for OFDM signals, where the first FMCW signal may be received within a symbol of the set of one or more symbols that may be allocated for the FMCW signals based on the control message, and where the first wireless device includes a network entity.

Some examples of the method, apparatuses, and non-transitory computer-readable medium described herein may further include operations, features, means, or instructions for receiving a control message that indicates the set of FMCW parameters, the set of FMCW parameters including a starting frequency of the first FMCW signal, a bandwidth of the first FMCW signal, a slope of the first FMCW signal, or any combination thereof, where the slope may be based on the bandwidth of the first FMCW signal and a duration of a symbol via which the first FMCW signal may be received.

Some examples of the method, apparatuses, and non-transitory computer-readable medium described herein may further include operations, features, means, or instructions for transmitting a control message that indicates the set of FMCW parameters, the set of FMCW parameters including a starting frequency of the first FMCW signal, a bandwidth of the first FMCW signal, a slope of the first FMCW signal, or any combination thereof, where the slope may be based on the bandwidth of the first FMCW signal and a duration of a symbol via which the first FMCW signal may be received, and where receiving the first FMCW signal may be based on the set of FMCW parameters.

Some examples of the method, apparatuses, and non-transitory computer-readable medium described herein may further include operations, features, means, or instructions for receiving a control message including a trigger for the first wireless device to perform OFDM channel estimation using FMCW signals, where using the first FMCW signal and the second FMCW signal to estimate the OFDM channel may be based on the trigger, and where the first wireless device includes a UE.

Some examples of the method, apparatuses, and non-transitory computer-readable medium described herein may further include operations, features, means, or instructions for receiving a control message including a trigger for the first wireless device to transmit a channel state information report based on the first FMCW signal and transmitting the channel state information report including a set of channel state information parameters based on receiving the trigger and estimating the OFDM channel.

Some examples of the method, apparatuses, and non-transitory computer-readable medium described herein may further include operations, features, means, or instructions for transmitting a control message including a trigger for a second wireless device to transmit the first FMCW signal.

In some examples of the method, apparatuses, and non-transitory computer-readable medium described herein, the first wireless device includes a UE or a network entity.

A method for wireless communication at a second wireless device is described. The method may include generating a FMCW signal, the FMCW signal for estimation, by a first wireless device, of an OFDM channel, transmitting the FMCW signal via the OFDM channel, and communicating OFDM signals with the first wireless device via the OFDM channel based on the estimation of the OFDM channel.

An apparatus for wireless communication is described. The apparatus may include a processor, memory coupled with the processor, and instructions stored in the memory. The instructions may be executable by the processor to cause the apparatus to generate a FMCW signal, the FMCW signal for estimation, by a first wireless device, of an OFDM channel, transmit the FMCW signal via the OFDM channel, and communicate OFDM signals with the first wireless device via the OFDM channel based on the estimation of the OFDM channel.

Another apparatus for wireless communication at a second wireless device is described. The apparatus may include means for generating a FMCW signal, the FMCW signal for estimation, by a first wireless device, of an OFDM channel, means for transmitting the FMCW signal via the OFDM channel, and means for communicating OFDM signals with the first wireless device via the OFDM channel based on the estimation of the OFDM channel.

A non-transitory computer-readable medium storing code for wireless communication at a second wireless device is described. The code may include instructions executable by a processor to generate a FMCW signal, the FMCW signal for estimation, by a first wireless device, of an OFDM channel, transmit the FMCW signal via the OFDM channel, and communicate OFDM signals with the first wireless device via the OFDM channel based on the estimation of the OFDM channel.

Some examples of the method, apparatuses, and non-transitory computer-readable medium described herein may further include operations, features, means, or instructions for transmitting one or more OFDM signals time division multiplexed with the FMCW signal within the OFDM channel.

Some examples of the method, apparatuses, and non-transitory computer-readable medium described herein may further include operations, features, means, or instructions for transmitting a capability message that indicates the second wireless device may be capable of transmitting FMCW signals for OFDM channel estimation, where the second wireless device includes a UE.

Some examples of the method, apparatuses, and non-transitory computer-readable medium described herein may further include operations, features, means, or instructions for receiving a capability message that indicates the first wireless device may be capable of estimating the OFDM channel using time domain FMCW signals, where the second wireless device includes a network entity.

Some examples of the method, apparatuses, and non-transitory computer-readable medium described herein may further include operations, features, means, or instructions for receiving a control message that indicates whether one or more symbols of the OFDM channel may be allocated for FMCW signals, where the FMCW signal may be transmitted within a symbol of the set of one or more symbols that may be allocated for the FMCW signals based on the control message, and where the second wireless device includes a UE.

Some examples of the method, apparatuses, and non-transitory computer-readable medium described herein may further include operations, features, means, or instructions for transmitting a control message that indicates whether one or more symbols of the OFDM channel may be allocated for FMCW signals or for OFDM signals, where the FMCW signal may be transmitted within a symbol of the one or more symbols that may be allocated for the FMCW signals, and where the second wireless device includes a network entity.

Some examples of the method, apparatuses, and non-transitory computer-readable medium described herein may further include operations, features, means, or instructions for receiving a control message that indicates a set of FMCW parameters that may be associated with the FMCW signal, the set of FMCW parameters including a starting frequency of the FMCW signal, a bandwidth of the FMCW signal, a slope of the FMCW signal, or any combination thereof, where the slope may be based on the bandwidth of the FMCW signal and a duration of a symbol via which the FMCW signal may be transmitted, and where transmitting the FMCW signal may be based on the set of FMCW parameters.

Some examples of the method, apparatuses, and non-transitory computer-readable medium described herein may further include operations, features, means, or instructions for transmitting a control message that indicates a set of FMCW parameters that may be associated with the FMCW signal, the set of FMCW parameters including a starting frequency of the FMCW signal, a bandwidth of the FMCW signal, a slope of the FMCW signal, or any combination thereof, where the slope may be based on the bandwidth of the FMCW signal and a duration of a symbol via which the FMCW signal may be transmitted, and where the estimation of the OFDM channel may be based on the set of FMCW parameters.

Some examples of the method, apparatuses, and non-transitory computer-readable medium described herein may further include operations, features, means, or instructions for transmitting a control message including a trigger for the first wireless device to perform OFDM channel estimation using FMCW signals, where the estimation of the OFDM channel may be based on the trigger, and where the second wireless device includes a network entity.

Some examples of the method, apparatuses, and non-transitory computer-readable medium described herein may further include operations, features, means, or instructions for transmitting a control message including a trigger for the first wireless device to transmit a channel state information report that may be based on the FMCW signal and receiving, based at least in part on the trigger, the channel state information report including a set of channel state information parameters.

Some examples of the method, apparatuses, and non-transitory computer-readable medium described herein may further include operations, features, means, or instructions for receiving a control message including a trigger for the second wireless device to transmit the FMCW signal, where transmitting the FMCW signal may be based on the trigger.

In some examples of the method, apparatuses, and non-transitory computer-readable medium described herein, the second wireless device includes a UE or a network entity.

### BRIEF DESCRIPTION OF THE DRAWINGS

FIG. 1 illustrates an example of a wireless communications system that supports estimating orthogonal frequency division multiplexing (OFDM) channels using frequency modulated continuous waveforms (FMCWs) in accordance with one or more aspects of the present disclosure.

FIG. 2 illustrates an example of an OFDM channel estimation scheme that supports estimating OFDM channels using FMCWs in accordance with one or more aspects of the present disclosure.

FIG. 3 illustrates an example of an OFDM channel estimation scheme that supports estimating OFDM channels using FMCWs in accordance with one or more aspects of the present disclosure.

FIG. 4 illustrates an example of a wireless communications system that supports estimating OFDM channels using FMCWs in accordance with one or more aspects of the present disclosure.

FIG. 5 illustrates an example of a process flow that supports estimating OFDM channels using FMCWs in accordance with one or more aspects of the present disclosure.

FIG. 6 illustrates an example of a process flow that supports estimating OFDM channels using FMCWs in accordance with one or more aspects of the present disclosure.

FIGS. 7 and 8 illustrate block diagrams of devices that support estimating OFDM channels using FMCWs in accordance with one or more aspects of the present disclosure.

FIG. 9 illustrates a block diagram of a communications manager that supports estimating OFDM channels using FMCWs in accordance with one or more aspects of the present disclosure.

FIG. 10 illustrates a diagram of a system including a UE that supports estimating OFDM channels using FMCWs in accordance with one or more aspects of the present disclosure.

FIG. 11 illustrates a diagram of a system including a network entity that supports estimating OFDM channels using FMCWs in accordance with one or more aspects of the present disclosure.

FIGS. 12 through 17 illustrate flowcharts showing methods that support estimating OFDM channels using FMCWs in accordance with one or more aspects of the present disclosure.

### DETAILED DESCRIPTION

In some systems, a wireless device may estimate an orthogonal frequency division multiplexing (OFDM) channel based on one or more received signals to improve reliability and throughput of transmissions and receptions by the wireless device. The wireless device may, in some cases, receive an OFDM signal via the OFDM channel. The wireless device may convert the received analog OFDM signal to a digital signal using an analog-to-digital converter (ADC). The received signal may be a time domain signal. The wireless device may subsequently perform a fast Fourier transform (FFT) on the time domain digital signal to convert the time domain digital signal to one or more frequency domain signals. The wireless device may use the frequency domain signals to estimate the OFDM channel in the frequency domain. In some examples, a sampling rate of the ADC at the wireless device may be relatively high to accurately convert the analog OFDM signals to digital form. Additionally, or alternatively, performing the FFT to convert the time domain signal to a frequency domain be relatively complex.

Techniques, systems, and devices described herein provided for improved OFDM channel estimation using frequency modulated continuous waveform (FMCW) signals. A transmitting device may transmit a first FMCW signal for channel estimation via an OFDM channel. A receiving device may receive the first FMCW signal and may use a set of FMCW parameters associated with the first FMCW signal to generate a second (e.g., local) FMCW signal. The receiving device may combine the first and second FMCW signals and may filter the combined signal (e.g., using a low pass filter (LPF), or some other type of filter). The receiving device may estimate the frequency domain OFDM channel by sampling the combined FMCW signal using a relatively low sampling rate. The sampling rate used by the receiving device may be based on one or more parameters of the OFDM channel, such as a bandwidth or a subband frequency size of the OFDM channel.

In some examples, the transmitting and receiving devices may exchange signaling to facilitate the OFDM channel estimation using FMCW signals. For example, one of the devices (e.g., a user equipment (UE)) may transmit a capability message to indicate that the device supports FMCW for channel estimation or supports transmission of an FMCW. In some examples, one or both of the devices may transmit one or more control message that allocate symbols in the OFDM channel (e.g., an OFDM resource grid) for FMCW transmissions, that indicate FMCW parameters, that trigger transmission of the FMCW signal, that trigger the channel estimation using the FMCW signal, or any combination thereof. In some examples, the signaling exchanged between the devices may be based on a type of the devices. The transmitting and receiving devices may each be a UE, a network entity, some other type of device, or any combination thereof.

The described techniques may thereby support estimation of a frequency domain OFDM channel based on FMCW signals, which may be referred to as FMCW-based OFDM channel estimation in some aspects herein. A sampling rate applied by the receiving device to estimate the frequency domain OFDM channel using the FMCW-based OFDM channel estimation techniques may be lower than a sampling rate used by a receiving device to estimate the frequency domain OFDM channel based on OFDM signals (e.g., channel state information reference signals (CSI-RSs), sounding reference signals (SRSs), demodulation reference signals (DMRSs), or any combination thereof). Additionally, or alternatively, the receiving device may estimate the frequency domain OFDM channel in the time domain using time domain signal processing (e.g., the receiving device may refrain from performing FFT) based on the FMCW signals, which may reduce complexity and power consumption as compared with OFDM-based estimation techniques in which FFT is applied.

Aspects of the disclosure are initially described in the context of wireless communications systems. Additional aspects are described in the with reference to OFDM channel estimation schemes and process flows. Aspects of the disclosure are further illustrated by and described with reference to apparatus diagrams, system diagrams, and flowcharts that relate to estimating OFDM channels using FMCWs.

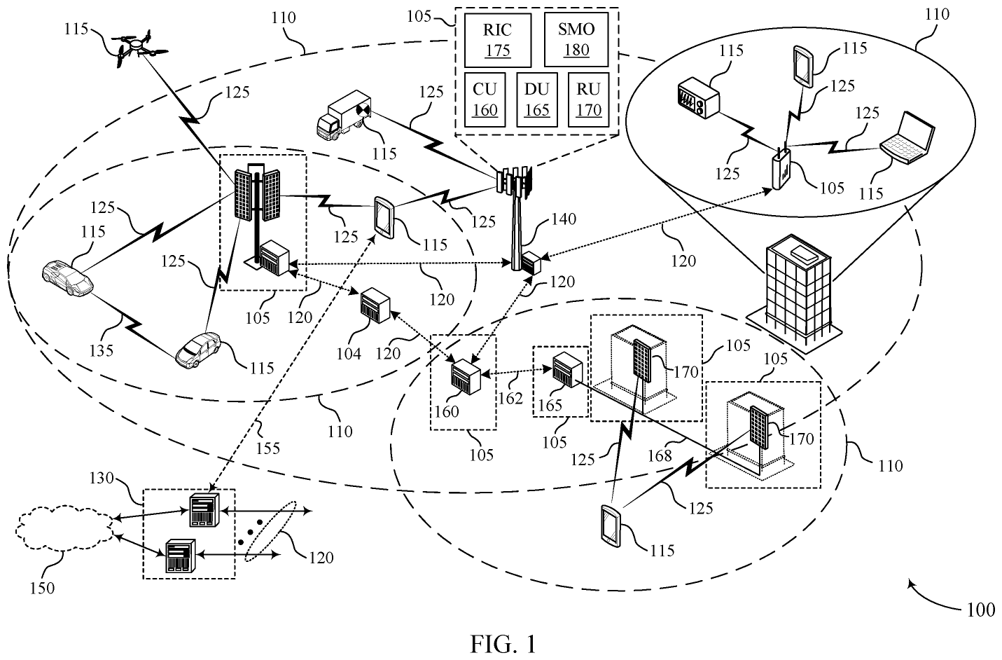

FIG. 1 illustrates an example of a wireless communications system 100 that supports estimating OFDM channels using FMCWs in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support estimating OFDM channels using FMCWs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as OFDM or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₙₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 To 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI-RS), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A waveform and multiple-access design that is used for wireless communications may be configured to support a relatively wide variety of use cases, such as mobile broadband, metaverse, massive internet-of-things (IoT), sidelink, massive spectrum aggregation or duplex, UE cooperation, other use cases, or any combination thereof. In some examples, the waveform and multiple-access design may support a relatively large variety of technologies, such as full duplex technologies, radio frequency sensing, positioning, physical layer security, other technologies, or any combination thereof. Additionally, or alternatively, the waveform and multiple-access design may be supported across multiple frequency ranges (e.g., mmW and beyond) as the use cases and technologies expand. In some examples, the waveform and multiple-access design may be configured to support relatively large amounts of connectivity and relatively high cell capacity (e.g., the waveform and multiple-access design may provide relatively efficient support for channel access for a relatively high quantity of users).

One or more waveforms used for wireless communications may be based on multiple design metrics. The design metrics may include, for example, spectrum efficiency, energy efficiency (e.g., power amplifier and processing power efficiency at transmitting and receiving devices, respectively), waveform processing complexity and latency, radio frequency impairments (e.g., error vector magnitude (EVM), or the like), spectrum confinement with a power amplifier model (e.g., in-band and out-of-band emissions), and support for relatively efficient multi-user or MIMO multiple-access. The one or more waveforms may be designed to support one or more channel conditions, such as fading (e.g., time variation or inter-symbol-interference (ISI)), phase noise, power amplifier nonlinearities, or any combination thereof. In some examples, the one or more waveforms may be designed based on digital pre-distortion (DPD) and digital post-distortion (DPoD) technology advancements, spectrum confinement for full duplex, joint sensing and common (JSAC) use cases, or any combination thereof.

Techniques, systems, and devices described herein may provide support for using FMCWs to improve channel estimation in OFDM systems. One or more devices in the wireless communications system 100 may support the FMCW-based OFDM channel estimation techniques described herein. For example, a transmitting device (e.g., a UE 115 or a network entity 105) may transmit a first FMCW signal via an OFDM channel. A receiving device (e.g., a UE 115 or a network entity 105 in communication with the transmitting device) may receive the first FMCW signal. The receiving device may generate a second FMCW signal (e.g., a local FMCW signal) based on a set of one or more FMCW parameters that are associated with the first FMCW signal. The set of one or more FMCW parameters may include a starting frequency of the first FMCW signal, a bandwidth of the first FMCW signal, a slope of the first FMCW signal, or any combination thereof. The receiving device may combine the first and second FMCW signals and filter the combined FMCW signal (e.g., using a low-pass filter (LPF)). The receiving device may sample the combined FMCW signal using a sampling rate that may be based on one or more parameters associated with the OFDM channel. The receiving device may use the samples to estimate the frequency domain OFDM channel using time domain signal processing techniques, which may reduce latency, reduce processing complexity, and improve channel estimation reliability.

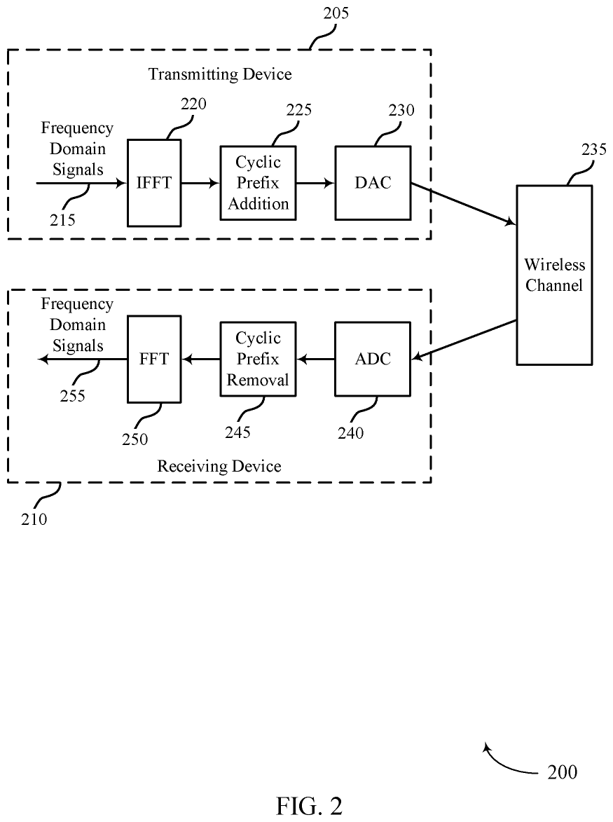

FIG. 2 illustrates an example of an OFDM channel estimation scheme 200 that supports estimating OFDM channels using FMCWs in accordance with one or more aspects of the present disclosure. In some examples, the OFDM channel estimation scheme 200 may implement aspects of the wireless communications system 100 described with reference to FIG. 1. In this example, a transmitting device 205 (e.g., a UE, a base station, an RU, a DU, a CU, an IAB node or some other device) and a receiving device 210 (e.g., a UE, a base station, an RU, a DU, a CU, an IAB node or some other device) may exchange OFDM signals via a wireless channel 235, which may be an OFDM channel. The receiving device 210 may estimate the wireless channel 235 using frequency domain signal processing.

The transmitting device 205 and the receiving device 210 may establish a connection for wireless communications via the wireless channel 235. The transmitting device 205 may generate an OFDM signal for transmission to the receiving device 210 via the wireless channel 235. To generate the OFDM signal, the transmitting device 205 may identify data scheduled for transmission to the receiving device 210. The data may include or be converted to a set of frequency domain signals 215 (e.g., {X(0), X(1), . . . X(N_{c}−1)}). The transmitting device 205 may perform an inverse fast Fourier transform (IFFT) 220 on the frequency domain signals 215 to convert the frequency domain signals 215 to a time domain signal (e.g., X(m)).

The transmitting device 205 may perform cyclic prefix addition 225 to the time domain signal. For example, the transmitting device 205 may add a cyclic prefix to the time domain signal to generate an OFDM signal. The transmitting device 205 may subsequently use a digital-to-analog converter (DAC) 230 to convert the time domain signal from a digital signal to an analog signal. In some examples, the transmitting device 205 may convert a real and imaginary portion of the digital time domain signal to the analog domain separately. The transmitting device 205 may transmit the analog time domain OFDM signal to the receiving device 210 via the wireless channel 235.

The receiving device 210 may receive the analog time domain OFDM signal and use an ADC 240 at the receiving device 210 to convert the received signal to a digital domain. In some examples, the receiving device 210 may convert a real portion and an imaginary portion of the analog signal to the digital domain separately. The receiving device 210 may perform cyclic prefix removal 245 to remove the cyclic prefix(es) from the time domain digital signal after using the ADC 240. After removing the cyclic prefixes, the receiving device 210 may perform FFT 250 on the digital time domain signal. The FFT 250 may convert the time domain signal to a frequency domain. That is, the FFT 250 may produce a set of frequency domain signals 255.

The receiving device 210 may use the set of frequency domain signals 255 produced by the FFT 250 to estimate a frequency domain OFDM channel (e.g., a frequency domain of the wireless channel 235). In some examples, to estimate a frequency domain OFDM channel based on OFDM signals, as described with reference to FIG. 2, the ADC 240 at the receiving device 210 may be a relatively high-rate ADC 240. That is, a sampling rate of the ADC 240 may be relatively high to accurately convert the analog OFDM signals to digital OFDM signals.

Example sampling rates of the ADC 240 that may be used for different configured subcarrier spacing (SCS) values are shown in Table 1.

TABLE 1
FFT Size, Subcarriers (sc), and Sampling Rate Per SCS

| SCS | 20 MHz | 50 MHz | 100 MHz | 200 MHz | 400 MHz |
|---|---|---|---|---|---|
| 15 kHz | 2048 FFT | 4096 FFT | N/A | N/A | N/A |
| | 1320 sc (110 | 3300 sc (275 | >275 PRBs | >275 PRBs | >275 PRBs |
| | PRBs) | PRBs) | | | |
| | 30.72 Msps | 61.44 Msps | | | |
| 30 kHz | 1024 FFT | 2048 FFT | 4096 FFT | N/A | N/A |
| | 660 sc (55 | 1644 sc (137 | 3300 sc (275 | >275 PRBs | >275 PRBs |
| | PRBs) | PRBs) | PRBs) | | |
| | 30.72 Msps | 61.44 Msps | 122.88 Msps | | |
| 60 kHz | 512 FFT | 1024 FFT | 2048 FFT | 4096 FFT | N/A |
| | 324 sc (27 | 816 sc (68 | 1644 sc (137 | 3300 sc (275 | >275 PRBs |
| | PRBs) | PRBs) | PRBs) | PRBs) | |
| | 30.72 Msps | 61.44 Msps | 122.88 Msps | 245.76 Msps | |
| 120 kHz | N/A | 512 FFT | 1024 FFT | 2048 FFT | 4096 FFT |
| | <20 PRBs | 408 sc (34 | 816 sc (68 | 1644 sc (137 | 3300 sc (275 |
| | | PRBs) | PRBs) | PRBs) | PRBs) |
| | | 61.44 Msps | 122.88 Msps | 245.76 Msps | 491.52 Msps |

The sampling rate may be defined in unites of mega-samples per second (Msps). The sampling rate may be calculated based on the SCS value and a respective FFT size and may be associated with a respective quantity of subcarriers (sc) (e.g., in quantities of physical resource blocks (PRBs)). For example, the sampling rate may be equal to a product of the SCS and the N_{FFT} size (e.g., 15 KHz*2048=30.72 MHz).

In some examples, performing the FFT 250 by the receiving device 210 may be associated with relatively high processing and complexity. Additionally, or alternatively, the ADC 240 at the receiving device 210 may be a relatively high rate ADC 240. A sampling rate used to convert the received analog signal to digital form, such as the sampling rates shown in Table 1, may be relatively high for the receiving device 210 to accurately convert OFDM signals and subsequently perform FFT 250.

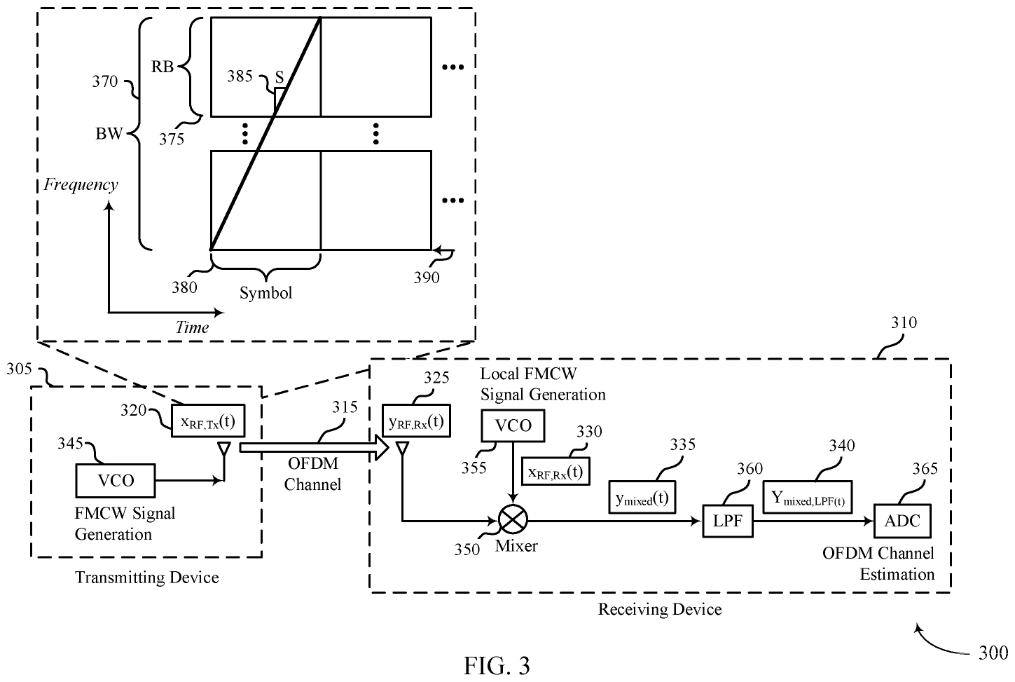

Techniques, systems, and devices described herein provide for a transmitting device 205 and a receiving device 210 to exchange FMCW signals via the wireless channel 235. The FMCW signals may be configured for channel estimation of an OFDM channel, and may support reduced processing complexity at the receiver. For example, the FMCW signals may be sampled at a reduced sampling rate as compared to OFDM signals, and may be used to estimate the frequency domain OFDM channel using time domain signal processing, such that the receiving device 210 may refrain from performing the FFT 250, which may reduce complexity as compared with using OFDM signals to estimate OFDM channels. The FMCW-based channel estimation techniques are described in further detail elsewhere herein, including with reference to FIGS. 3-6.

FIG. 3 illustrates an example of an OFDM channel estimation scheme 300 that supports estimating OFDM channels using FMCWs in accordance with one or more aspects of the present disclosure. In some examples, the OFDM channel estimation scheme 300 may implement aspects of the wireless communications system 100 described with reference to FIG. 1. In this example, a transmitting device 305 (e.g., a UE, a base station, an RU, a DU, a CU, an IAB node or some other device) and a receiving device 310 (e.g., a UE, a base station, an RU, a DU, a CU, an IAB node or some other device) may exchange an FMCW signal via an OFDM channel 315. The FMCW signal may be used to facilitate channel estimation of the frequency domain OFDM channel by the receiving device 310.

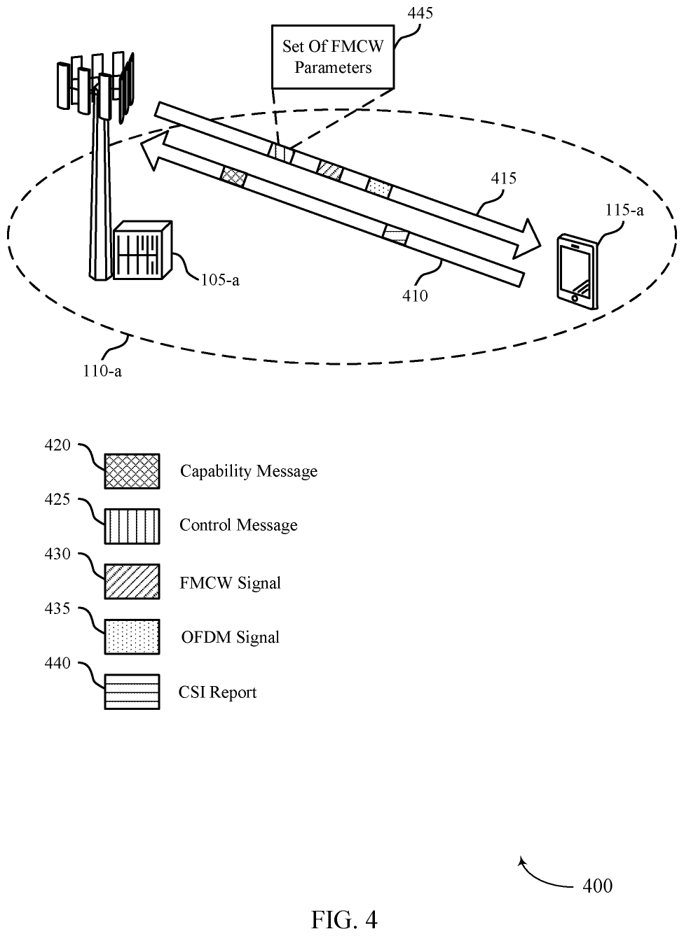

The transmitting device 305 and the receiving device 310 may establish a connection for wireless communications via an OFDM channel 315. The devices may be UEs 115, network entities 105, other devices, or any combination thereof. In some examples, the devices may exchange one or more capability messages, control messages, or both to initiate an FMCW-based OFDM channel estimation procedure described herein. Such signaling may be described in further detail elsewhere herein, including with reference to FIGS. 4-6.

After the FMCW-based OFDM channel estimation procedure is initiated, the transmitting device 305 may generate an FMCW signal 320 (e.g., a first FMCW signal). In some examples, the transmitting device 305 may generate the FMCW signal 320 in an analog domain using a voltage controlled oscillator (VCO) 345. The transmitting device 305 may transmit the FMCW signal 320 via the OFDM channel 315 using at least one antenna element at the transmitting device 305. The analog domain FMCW signal 320 generated and transmitted by the transmitting device 305 may be represented by x_{RF,Tx}(t), shown in Equation 1.

$${x}_{RF , Tx} ( t ) = cos ( 2 π ( {f}_{c} + \frac{S}{2} t ) t + {ϕ}_{Tx} ) \qquad ( 1 )$$

As shown in Equation 1, the FMCW signal 320 may be a time-domain signal (e.g., a function of time (t)). In the example of Equation 1, f_{c} may represent a starting frequency 390 of the FMCW signal 320, S may represent a slope 385 of the FMCW signal 320, and φ_{Tx} may represent a phase of the transmitting device 305.

As illustrated in FIG. 3, the FMCW signal 320 may be associated with a waveform signal transmitted via a symbol 380 of the OFDM channel 315 in the time domain and a bandwidth 370 (e.g., BW) of the OFDM channel 315 in the frequency domain. The bandwidth 370 may include one or more resource blocks 375 in the frequency domain. In some examples, each resource block 375 may include a set of resource elements in the frequency domain. The OFDM channel 315 may include multiple symbols 380 in the time domain. A duration or length of each symbol 380 may correspond to a length of an OFDM symbol, or a length of an OFDM symbol and a respective cyclic prefix duration, or a partial length of an OFDM symbol, or a partial length of an OFDM symbol and a respective cyclic prefix duration, or some other length longer than the length of the OFDM symbol and the length of the OFDM symbol and cyclic prefix duration, or some other symbol duration, or any combination thereof. The FMCW signal 320 may span frequencies between the starting frequency 390 and a sum of the starting frequency 390 and the bandwidth 370 (e.g., {fₑ, f_{c}+BW}). The slope 385 of the FMCW signal 320 may correspond to a quotient of the bandwidth 370 and a duration of the symbol 380 via which the FMCW signal 320 is transmitted, as shown by Equation 2.

$$S = \frac{BW}{{T}_{sym}} = \frac{{N}_{RE} \cdot Δ f}{{T}_{sym}} = {N}_{RE} \cdot Δ f \cdot Δ f \qquad ( 2 )$$

In the example of Equation 2, T_{sym} may represent the duration of the symbol 380, N_{RE} may represent a quantity of resource elements in the bandwidth 370, and Δf may represent an SCS. In this example, the slope may be calculated based on a symbol duration that corresponds to a length of an OFDM symbol. For example, the duration of the symbol 380 may be an inverse of an SCS

$$( e . g . , {T}_{sym} = \frac{1}{Δ f} ) .$$

The radio frequency FMCW signal 325 that is received by the receiving device 310 via the OFDM channel 315 in response to the FMCW signal 320 transmitted by the transmitting device 305 may be represented by y_{RF,Rx}(t), shown in Equation 3.

$${y}_{RF , Rx} ( t ) = {\sum }_{p = 0}^{P - 1} {A}_{p} {x}_{RF , Tx} ( t - {τ}_{p} ) + n ( t ) = {\sum }_{p = 0}^{P - 1} {A}_{p} cos ( 2 π ( {f}_{c} + \frac{S}{2} ( t - {τ}_{p} ) ) ( t - {τ}_{p} ) + {ϕ}_{Tx} ) + n ( t ) \qquad ( 3 )$$

In the example of Equation 3, P may represent a quantity of channel delay paths (e.g., a quantity of multi-paths) associated with the OFDM channel 315, and τₚ may represent a given channel delay with index p. That is, the received FMCW signal 325 may be sampled over various channel delays (e.g., p=0 to P−1). A_{P} may represent conditions of the OFDM channel 315 and n(t) may represent channel noise. In some examples, the channel noise may be associated with a relatively small value relative to the other values that define the radio frequency FMCW signal 325 that is received by the receiving device 310 in Equation 3.

As described herein, the receiving device 310 may generate an FMCW signal 330 at the receiving device. The FMCW signal 330 generated at the receiving device 310 may be referred to as a second FMCW signal or a local FMCW signal. The receiving device 310 may generate the FMCW signal 330 in the analog domain using a VCO 355 at the receiving device 310. The receiving device 310 may generate the FMCW signal 330 at the same time as or after receiving the FMCW signal 325. The FMCW signal 330 generated by the receiving device 310 may be represented by x_{RF,Rx}(t), shown in Equation 4.

$${x}_{RF , Rx} ( t ) = exp ( - j ( 2 π ( {f}_{c} + \frac{S}{2} t ) t - {ϕ}_{Rx} ) ) \qquad ( 4 )$$

As shown in Equation 4, the receiving device 310 may generate the FMCW signal 330 based on a set of FMCW parameters associated with the FMCW signal 320 transmitted by the transmitting device 305. The set of FMCW parameters may include, for example, the starting frequency 390 (f_{c}) of the FMCW signal 320, the slope 385 (S) of the FMCW signal 320, an initial phase of a transmitting device (e.g., φ_{Tx}), or any combination thereof. That is, the FMCW signal 330 generated by the receiving device 310 may have a same starting frequency 390 and slope 385 as the FMCW signal 320 generated by the transmitting device 305. In the example of Equation 4, φ_{Rx} may represent a phase of the receiving device 310. In some examples, the phase of the receiving device may be the same as the phase of the transmitting device (e.g., φ_{Tx}=φ_{Rx}). In some examples, the transmitting device 305 may transmit a control message that indicates the set of FMCW parameters for generation, by the receiving device 310, of the FMCW signal 330. Additionally, or alternatively, the receiving device 310 may transmit a control message that indicates the set of FMCW parameters for generation, by the transmitting device 305, of the FMCW signal 320 and for generation, by the receiving device 310, of the FMCW signal 330, as described in further detail elsewhere herein, including with reference to FIGS. 4 through 6.

The FMCW signal 320 transmitted by the transmitting device 305 and the FMCW signal 330 generated at the receiving device 310 may have similar FMCW structures. For example, both signals may be wideband signals (e.g., may span a full bandwidth 370 of the OFDM channel 315), may span a duration of a symbol 380 in the OFDM channel 315, may be associated with the starting frequency 390, and may be associated with the slope 385. In some examples, the FMCW signal 320 transmitted by the transmitting device 305 may be a real signal. For example, the FMCW signal 320 may include a single stream (e.g., a cosine stream, as shown in Equation 1). The FMCW signal 330 generated by the receiving device 310 may include two streams (e.g., a sinusoidal stream and a cosine stream) for channel estimation. That is, the exponential function in the FMCW signal 330 generated by the receiving device 310 may be designed for channel estimation. In some examples, the receiving device 310 may be configured with a function for generating the FMCW signal 330 for channel estimation, or the receiving device 310 may receive a control message that indicates the function for generating the FMCW signal 330 for channel estimation.

After generating the FMCW signal 330 configured for channel estimation, the receiving device 310 may generate a combined FMCW signal 335 (e.g., y_{mixed}(t)). To generate the combined FMCW signal 335, the receiving device 310 may combine the FMCW signal 325 received at the receiving device 310 with the locally generated FMCW signal 330 using a mixer 350. The mixer 350 may represent an example of one or more components (e.g., hardware, software, or both) of the receiving device 310 that are configured to combine two or more time-domain FMCW signals. In some examples, the combining may include multiplying the FMCW signals (e.g., y_{mixed}(t)=y_{RF,Rx}(t)x_{RF,Rx}(t)).

The receiving device 310 may filter the combined FMCW signal 335 using an LPF 360 at the receiving device 310. The LPF 360 may generate a combined and filtered FMCW signal 340 (e.g., y_{mixed,LPF}(t)). The LPF 360 may represent an example of a component of the receiving device 310 that is configured to filter signals, or a function supported by the receiving device 310, or both. For example, the receiving device 310 may apply an LPF function to the combined FMCW signal 335 (e.g., y_{mixed,LPF}(t)=LPF[y_{RF,Rx}(t)x_{RF,UE}(t)]). The combined and filtered FMCW signal 340 may be represented by Equation 5.

$${y}_{mixed , LPF} ( t ) = {\sum }_{p = 0}^{P - 1} \frac{{A}_{p}}{2} exp ( - j ( 2 π ( {f}_{c} - \frac{S}{2} {τ}_{p} ) {τ}_{p} + {ϕ}_{Rx} - {ϕ}_{Tx} ) ) exp ( - j 2 π S {τ}_{p} \cdot t ) + \tilde{n} ( t ) \qquad ( 5 )$$

Equation 5 may be simplified according to Equation 6.

$${y}_{mixed , LPF} ( t ) = {\sum }_{p = 0}^{P - 1} {β}_{p} exp ( - j 2 π S {τ}_{p} \cdot t ) + \tilde{n} ( t ) , \qquad ( 6 )$$

$$where {β}_{p} = \frac{{A}_{p}}{2} exp ( - j ( 2 π {f}_{c} {τ}_{p} ) ) exp ( j ( 2 π ( \frac{S}{2} {τ}_{p} ) {τ}_{p} - {ϕ}_{Rx} + {ϕ}_{Tx} ) )$$

In some examples, the second exponential function in βₚ may represent a channel estimation error that may be ignored to further simplify Equation 6. For example, one half of the second exponential function of βₚ (e.g.,

$$( e . g . , \frac{1}{2} exp ( j ( 2 π ( \frac{S}{2} {τ}_{p} ) {τ}_{p} - {ϕ}_{Rx} + {ϕ}_{Tx} ) ) )$$

may be associated with channel estimation error. However, if a value of τₚ, is relatively small, the channel estimation error may also be relatively small (e.g., negligible). In some examples, the channel noise included in the radio frequency FMCW signal 325 (e.g., y_{RF,Rx}(t)) that is received by the receiving device 310 may be represented by ñ(t) after the signal is combined with the generated FMCW signal 330 and filtered using the LPF 360. As described with reference to Equation 3, the channel noise ñ(t) may be associated with a relatively small value relative to the other values that define the combined and filtered FMCW signal 340 shown in Equations 5 and 6.

After combining and filtering the FMCW signals, the receiving device 310 may perform frequency domain OFDM channel estimation using time-domain signal processing based on sampling the combined and filtered FMCW signal 340. The receiving device 310 may use an ADC 365 to sample the combined and filtered FMCW signal 340 in the time domain. A sampling rate used to sample the combined and filtered FMCW signal 340 may be based on one or more parameters associated with the OFDM channel 315. For example, the sampling rate may be based on a frequency range of one or more subbands in the OFDM channel 315 (e.g., the sampling rate,

$$\frac{1}{{T}_{s}} ,$$

may be equal to an inverse of

$${T}_{s} = \frac{1}{{F}_{s}} = \frac{{f}_{subband}}{S} ) .$$

The subband frequency range, f_{subband}, may represent a granularity at which the receiving device 310 can estimate the OFDM channel 315 in the frequency domain.

The sampling by the receiving device 310 as part of the OFDM channel estimation may produce a sampling sequence, D_{Rx}(k), which may represent a set of values associated with the OFDM channel estimation. The sampling sequence may have a granularity of f_{subband}. For example, each value of D_{Rx}(k) may represent an example of an estimated value of a respective frequency subband of the OFDM channel 315. The sampling sequence, D_{Rx}(k), is shown by Equation 7.

$${D}_{Rx} ( k ) = {\sum }_{p = 0}^{P - 1} {β}_{p} exp ( - j 2 {πτ}_{p} \cdot k \cdot \frac{S}{{F}_{s}} ) + \tilde{n} ( t ) = {\sum }_{p = 0}^{P - 1} {β}_{p} exp ( - j 2 {πτ}_{p} \cdot k \cdot {f}_{subband} ) + \tilde{n} ( t ) , k = 0 , 1 , … , K - 1 \qquad ( 7 )$$

In the example of Equation 7, Fₛ may represent the sampling rate used by the receiving device 310 to estimate the OFDM channel 315. K may represent a total quantity of subbands in the OFDM channel 315, which may also correspond to a total quantity of samples in the sampling sequence. Accordingly, each value of k may represent an index of a respective subband of the total quantity of subbands. In one example, if the subband frequency range f_{subband} of the OFDM channel 315 is equal to one resource element, then the sampling sequence may include a respective sample or estimated value of each resource element in the OFDM channel 315 (e.g., per comb). In some examples, the subband frequency range f_{subband} may be any other granularity, such as a set of two or more resource elements, a resource block, or some other frequency range.

The receiving device 310 may thereby estimate the frequency domain OFDM channel 315 using time domain signal processing and with a granularity of f_{subband} based on the FMCW signal 325 received at the receiving device 310 and the FMCW signal 330 generated by the receiving device 310. The described FMCW-based OFDM channel estimation techniques may be performed by the receiving device 310 in the time domain using time domain signal processing. That is, the receiving device 310 may refrain from applying FFT or other frequency transforms when using the FMCW signals to estimate the frequency domain OFDM channel 315. By performing the OFDM channel estimation in the time domain, the receiving device 310 may reduce processing complexity, latency, and power consumption as compared with other OFDM channel estimation techniques performed at least partially in the frequency domain (e.g., using FFT). Additionally, or alternatively, the receiving device 310 may estimate the frequency domain OFDM channel 315 using both wideband radio frequency processing and narrowband radio frequency processing. For example, the FMCW signal 325 received at the receiving device 310 may be a wideband signal in the radio frequency, and after the LPF 360, the combined and filtered FMCW signal 340 may be a narrowband signal for baseband processing.

The sampling rate used by the receiving device 310 to estimate the frequency domain OFDM channel 315 using FMCW signals may be relatively low. The sampling rate described herein may be based on the slope 385 of the FMCW signals and the frequency granularity f_{subband}. For example, the sampling rate may be equal to

$$\frac{S}{{f}_{subband}} = \frac{{N}_{RE} \cdot Δ f \cdot Δ f}{{k}_{subband} \cdot Δ f} = \frac{{N}_{RE} \cdot Δ f}{{k}_{subband}} ,$$

where k_{subband} represents a quantity of resource elements in each frequency subband (e.g., each sampled portion of the frequency domain OFDM channel 315). A sampling rate of some OFDM-based OFDM channel estimation techniques (e.g., as described with reference to FIG. 2) may be equal to a product of an FFT size, N_{FFT}, and an SCS, Δf (e.g., N_{FFT}·Δf). Thus, a ratio of the sampling rate of the FMCW-based OFDM channel estimation described herein relative to the OFDM-based OFDM channel estimation techniques may be represented by γ, as shown in Equation 8.

$$γ = \frac{{N}_{RE} \cdot Δ f}{{k}_{subband} \cdot Δ f \cdot {N}_{fft}} = \frac{{N}_{RE}}{{k}_{subband} \cdot {N}_{fft}} \qquad ( 8 )$$

As shown by Equation 8, the ratio between the sampling rate of the FMCW-based OFDM channel estimation techniques and the OFDM-based OFDM channel estimation techniques may be relatively low. That is, the sampling rate of the FMCW-based OFDM channel estimation techniques may be relatively low compared to the OFDM-based OFDM channel estimation techniques. In one example, if there are 273*12 resource elements in the bandwidth 370 (e.g., N_{RE}=273*12), and each subband includes a single resource element (e.g., k_{subband}=1), the ratio, may be equal to 0.8. That is, in such cases, the FMCW-based OFDM channel estimation techniques may produce an ADC sampling gain of approximately 20 percent. In some examples, such as for scenarios in which the receiving device (e.g., a UE 115) reports channel state information (CSI) or precoding matrix indicator (PMI), the subband size may be, at a minimum, equal to

$$\frac{{N}_{RE}}{37}$$

because a maximum quantity of subbands (e.g., N₃) that may be reported via the CSI or PMI report may be 37.

Table 2 includes example sampling rates to achieve accurate estimations of the frequency domain OFDM channel 315 using the FMCW-based OFDM channel estimation techniques described herein in comparison with example sampling rates to achieve accurate estimations of the frequency domain OFDM channel 315 using other OFDM channel estimation techniques in the frequency domain, as described with reference to FIG. 2. The example sampling rates shown in Table 2 represent example sampling rates that may be used by the receiving device 310 to accurately estimate the OFDM channel 315 with a granularity of four resource blocks 375 when the channel bandwidth 370 is 50 MHz.

TABLE 2
Comparison Of Sampling Rates For Different
Channel Estimation Techniques

| | | | OFDM Channel |
|---|---|---|---|
| | | | Estimation In |
| | FMCW-Based OFDM Channel | | The Frequency |
| | Estimation In The Time Domain | | Domain |
| | \|S\| (10¹²Hz²) | Fs (MHz) | Fs (MHz) |
| 15 kHz SCS | 0.75 | 1.04 | 61.44 |
| Tsym = 66.67 usec, | | | |
| w/o CP fsubband = | | | |
| 0.72 MHz | | | |
| 30 kHz SCS | 1.5 | 1.04 | 61.44 |
| Tsym = 33.33 usec, | | | |
| w/o CP fsubband = | | | |
| 1.44 MHz | | | |
| 60 kHz SCS | 3 | 1.04 | 61.44 |
| Tsym = 16.67 usec, | | | |
| w/o CP fsubband = | | | |
| 2.88 MHz | | | |
| 120 kHz SCS | 6 | 1.04 | 61.44 |
| Tsym = 8.333 usec, | | | |
| w/o CP fsubband = | | | |
| 5.76 MHz | | | |

As shown in Table 2, the FMCW-based channel estimation techniques described herein may reduce the sampling rate by a relatively large amount relative to OFDM-based channel estimation. For example, a sampling rate used by the receiving device 310 to estimate the OFDM channel 315 with a granularity of four resource blocks 375 when the channel bandwidth 370 is 50 MHz and using FMCW signals may be approximately 1.69 percent of the sampling rate that may be used by the receiving device 310 if OFDM-based channel estimation is performed in the same scenario.

The FMCW-based OFDM channel estimation described herein may reliably estimate the frequency domain OFDM channel 315 using the reduced sampling rate. For example, an accuracy of the FMCW-based OFDM channel estimation techniques may be relatively similar to an accuracy of OFDM-based OFDM channel estimation techniques using frequency domain reference signals across a range of packet delay protocols, SCS values, and bandwidths when compared with benchmark values. That is, the described techniques may maintain or improve accuracy and reliability of estimations of frequency domain OFDM channels 315 while reducing processing and power consumption.

FIG. 4 illustrates an example of a wireless communications system 400 that supports estimating OFDM channels using FMCWs in accordance with one or more aspects of the present disclosure. The wireless communications system 400 may implement or be implemented by aspects of the wireless communications system 100 or the OFDM channel estimation scheme 300 as described with reference to FIGS. 1 and 3. For example, the wireless communications system 400 may include a network entity 105-a and a UE 115-a, which may represent examples of a network entity 105 and a UE 115 as described with reference to FIGS. 1-3. The network entity 105-a may communicate with the UE 115-a within a geographic coverage area 110-a and via an uplink communication link 410 and a downlink communication link 415. In this example, the network entity 105-a may transmit an FMCW signal 430 to the UE 115-a to use for estimating an OFDM channel.

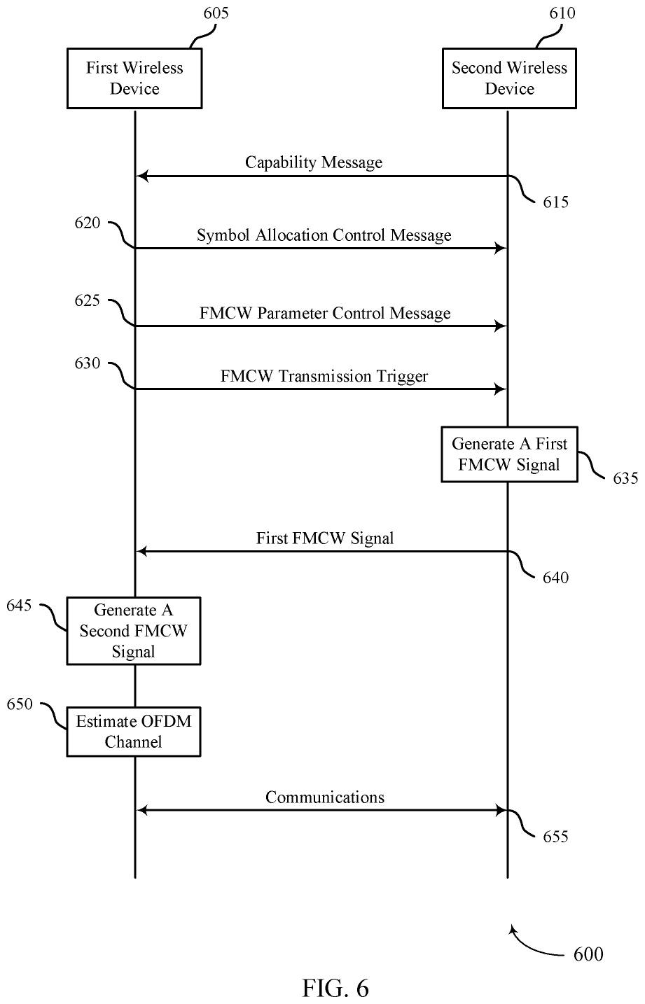

The network entity 105-a and the UE 115-a may represent examples of transmitting and receiving devices. As used herein, the transmitting device may refer to the wireless device that transmits an FMCW signal 430, and the receiving device may refer to the wireless device that receives the FMCW signal 430. Accordingly, in the example illustrated in FIG. 4, the network entity 105-a may be the transmitting device and the UE 115-a may be the receiving device, which may represent examples of the transmitting device 305 and the receiving device 310 described with reference to FIG. 3. Although the network entity 105-a is illustrated as the transmitting device in the example illustrated in FIG. 4, it is to be understood that, in some examples, the UE 115-a may be the transmitting device and may transmit the FMCW signal 430 to the network entity 105-a, as described in further detail elsewhere herein, including with reference to FIG. 6.

The UE 115-a may establish a connection with the network entity 105-a for wireless communications via the uplink communication link 410 and the downlink communication link 415. The UE 115-a may transmit a capability message 420 to the network entity 105-a via the uplink communication link 410 after establishing the connection. The capability message 420 may indicate that the UE 115-a is capable of receiving FMCW signals 430. The capability message 420 may be an example of an uplink control information (UCI) message, a medium access control-control element (MAC-CE), or some other type of uplink signaling. The UE 115-a may, in some examples, transmit multiple capability messages 420 dynamically or semi-persistently.

The network entity 105-a may receive the capability message 420 and determine that the UE 115-a is capable of receiving FMCW signals 430 and performing OFDM channel estimation based on the FMCW signals 430. The network entity 105-a may thereby determine to initiate an FMCW-based OFDM channel estimation procedure. The network entity 105-a may transmit one or more control messages 425 to the UE 115-a via the downlink communication link 415 to facilitate the FMCW-based OFDM channel estimation procedure. The one or more control messages 425 may include, for example, symbol allocation information, FMCW parameter information, a channel estimation trigger, or any combination thereof.

In some examples, a first control message 425 may indicate whether each symbol of a set of symbols in an OFDM channel are allocated for FMCW signals 430 or OFDM signals 435. The FMCW signals 430 and OFDM signals 435 may be multiplexed in the time domain across symbols of the OFDM channel, and the first control message 425 may indicate which symbols are allocated for which type of signaling. A second control message 425 may indicate a set of one or more FMCW parameters 445 the network entity 105-a is going to use to transmit an FMCW signal 430. The set of FMCW parameters 445 may include a bandwidth of the FMCW signal 430, a starting frequency of the FMCW signal 430, a slope of the FMCW signal 430, an initial phase of the FMCW signal 430, or any combination thereof, as described in further detail elsewhere herein, including with reference to FIG. 3. In some examples, the network entity 105-a may transmit an RRC configuration to the UE 115-a after establishing communications with the UE 115-a, and the RRC configuration may configure one or more sets of FMCW parameters 445. In such cases, the second control message 425 may be configured to indicate (e.g., via a pointer) an index of one of the multiple configured sets of FMCW parameters 445.

In some examples, a third control message 425 transmitted by the network entity 105-a to the UE 115-a may include a trigger (e.g., a request or other triggering information) for the UE 115-a to perform OFDM channel estimation using FMCW signals 430. In some examples, the network entity 105-a may transmit a single control message that includes the symbol allocation information, the set of FMCW parameters 445, and the OFDM channel estimation trigger. The control messages 425 may be downlink control information (DCI) messages, RRC messages, MAC-CE signaling, other types of downlink messages, or any combination thereof. The network entity 105-a may transmit the one or more control messages 425 dynamically or semi-statically. In some examples, the network entity 105-a may transmit the one or more control messages 425 based on (e.g., in response to or after) receiving the capability message 420 from the UE 115-a. That is, the network entity 105-a may transmit control messages 425 to facilitate the FMCW-based OFDM channel estimation procedure based on the UE 115-a indicating that the UE 115-a is capable of receiving FMCW signals 430.

The network entity 105-a may subsequently transmit a first FMCW signal 430 to the UE 115-a via the downlink communication link 415. The network entity 105-a may transmit the first FMCW signal 430 based on (e.g., using, in accordance with) the set of FMCW parameters 445 indicated via at least one of the one or more control messages 425. The first FMCW signal 430 may be transmitted via an OFDM channel and may be configured to assist with estimation, by the UE 115-a, of a frequency domain OFDM channel.

The UE 115-a may receive the first FMCW signal 430 via the OFDM channel, and the UE 115-a may generate a second FMCW signal (e.g., a local FMCW signal). The UE 115-a may estimate the OFDM channel based on samples of a combined FMCW signal including a combination of the first FMCW signal 430 and the second FMCW signal. A sampling rate used by the UE 115-a to sample the combined FMCW signal and estimate the frequency domain OFDM channel may be relatively low, as described in further detail elsewhere herein, including with reference to FIG. 3.

In some examples, the UE 115-a may transmit a report, such as the CSI report 440, that indicates information associated with the OFDM channel estimation based on the FMCW signals. The network entity 105-a may transmit a control message 425 that includes a trigger or request for the UE 115-a to transmit the CSI report 440, and the UE 115-a may generate and transmit the CSI report 440 via the uplink communication link 410 based on the trigger. The network entity 105-a and the UE 115-a may adjust one or more parameters for subsequent communications based on the channel estimation, which may improve throughput and reliability of subsequent communications between the network entity 105-a and the UE 115-a.

Although the network entity 105-a is illustrated as the transmitting device in the example of FIG. 4, it is to be understood that, in some examples, the UE 115-a may be the transmitting device. For example, the UE 115-a may transmit the first FMCW signal 430 via the uplink communication link 410 to the network entity 105-a, and the network entity 105-a may generate a local FMCW signal and estimate the frequency domain OFDM channel based on time domain samples of the first FMCW signal 430 and the local FMCW signal. In such cases, the capability message 420 transmitted by the UE 115-a may indicate that the UE 115-a is capable of transmitting FMCW signals 430. The control messages 425 transmitted by the network entity 105-a may include the symbol allocation information, the set of FMCW parameters 445, and a trigger for the UE 115-a to transmit the first FMCW signal 430 (e.g., via the uplink communication link 410). The UE 115-a may transmit the first FMCW signal 430 via a symbol allocated for FMCW based on the indicated set of FMCW parameters 445 and the trigger.

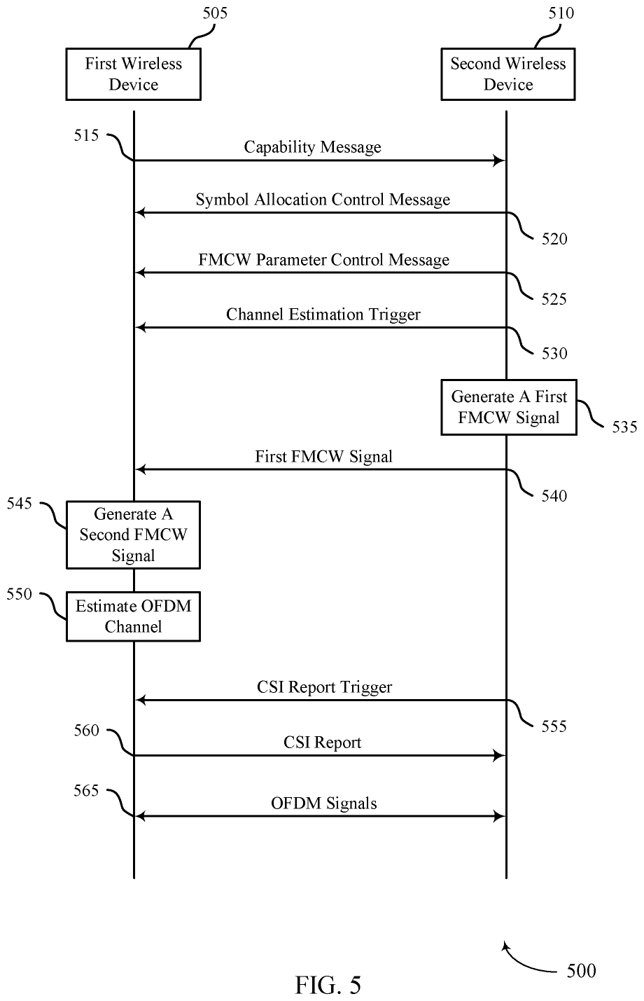

The devices in the wireless communications system 400 may thereby exchange FMCW signals 430 configured for estimation of a frequency domain OFDM channel using time domain signal processing (e.g., without performing FFT) and a relatively low sampling rate. The network entity 105-a may determine to transmit one or more control messages or other signaling to facilitate the FMCW-based OFDM channel estimation based on a capability of the UE 115-a to either transmit or receive FMCW signals 430. Examples of signaling that may be exchanged between the transmitting and receiving devices are described in further detail elsewhere herein, including with reference to FIGS. 5 and 6.

FIG. 5 illustrates an example of a process flow 500 that supports estimating OFDM channels using FMCWs in accordance with one or more aspects of the present disclosure. The process flow 500 may implement or be implemented by aspects of the wireless communications systems 100 and 400 or the OFDM channel estimation scheme 300. For example, the process flow 500 illustrates communications between a first wireless device 505 and a second wireless device 510, which may represent aspects of corresponding devices as described with reference to FIGS. 1-4. In this example, the first wireless device 505 may represent an example of a UE 115, and the second wireless device 510 may represent an example of a network entity 105. In some examples, the devices may exchange signaling to support FMCW-based OFDM channel estimation.

In the following description of the process flow 500, the operations between the first wireless device 505 and a second wireless device 510 may be performed in different orders or at different times. Some operations may also be left out of the process flow 500, or other operations may be added. Although the first wireless device 505 and a second wireless device 510 are shown performing the operations of the process flow 500, some aspects of some operations may also be performed by one or more other wireless devices.

At 515, the first wireless device 505 may transmit a capability message to the second wireless device 510. The capability message may indicate whether the first wireless device 505 is capable of receiving FMCW signals (e.g., an FMCW reception capability). In some examples, the capability message may indicate whether the first wireless device 505 is capable of estimating a frequency domain OFDM channel based on FMCW signals.

At 520, the second wireless device 510 may transmit a first control message, which may be referred to as a symbol allocation control message in some aspects herein. The first control message may indicate whether one or more symbols of the OFDM channel are allocated for FMCW signals or OFDM signals. For example, the first control message may include a bitmap or one or more indices configured to allocate a first set of symbols for transmission and reception of OFDM signals and a second set of symbols for transmission and reception of FMCW signals. The OFDM signals and the FMCW signals may be time division multiplexed across the symbols of the OFDM channel. The second wireless device 510 may transmit the first control message dynamically or semi-persistently to the first wireless device 505 to indicate symbol allocations to the first wireless device 505. The first control message may be, for example, a DCI message, a MAC-CE, an RRC message, or any combination thereof.

At 525, the second wireless device 510 may transmit a second control message, which may be referred to as an FMCW parameter control message in some aspects herein. The second control message may indicate a set of FMCW parameters associated with a first FMCW signal to be transmitted by the second wireless device 510. The set of FMCW parameters may include a starting frequency of the first FMCW signal, a bandwidth of the first FMCW signal, a slope of the first FMCW signal, or any combination thereof (e.g., {f_{c}}, {BW}, {S}). The starting frequency, bandwidth, and slope may represent examples of corresponding parameters described with reference to FIG. 3. In some examples, the slope may be based on the bandwidth of the first FMCW signal and a duration of a symbol via which the first FMCW signal is to be transmitted.

As described in further detail with reference to FIG. 4, the second control message may be a DCI message, a MAC-CE, an RRC message, some other type of control signaling, or any combination thereof. The second wireless device 510 may transmit the second control message (e.g., an indication of the FMCW parameters) dynamically or semi-persistently. In some examples, the second wireless device 510 may transmit one or more RRC messages that may each configure (e.g., pre-configure) a set of FMCW parameters, and the second control message may be a DCI message or MAC-CE signaling that indicates, to the first wireless device 505, an index to one of the sets of FMCW signals. Additionally, or alternatively, the second wireless device 510 may transmit a single RRC message that configures multiple sets of FMCW parameters, and the second control message may be a DCI message or MAC-CE signaling that indicates, to the first wireless device 505, an index to one of the sets of FMCW signals.

At 530, the second wireless device 510 may transmit a third control message to the first wireless device 505. The third control message may be referred to as a channel estimation trigger in some aspects herein. The channel estimation trigger may trigger the first wireless device 505 to perform channel estimation through FMCW. That is, the channel estimation trigger may include a request, instructions, or an indication to trigger the first wireless device 505 to start monitoring for FMCW signals to use for estimating a frequency domain OFDM channel.

Although the symbol allocation control message, the FMCW parameter control message, and the channel estimation trigger (e.g., the first through third control messages) are illustrated as separate control messages, it is to be understood that the second wireless device 510 may transmit any quantity of control messages to indicate any combination of the described symbol allocations, FMCW parameters, and channel estimation trigger. In some examples, the second wireless device 510 may transmit a single control message (e.g., a single DCI, MAC-CE or RRC message) that indicates each of the symbol allocation for FMCW, the set of FMCW parameters, and the channel estimation trigger. Additionally, or alternatively, the second wireless device 510 may transmit two control messages, to indicate the symbol allocation for FMCW and the set of FMCW parameters, respectively. In some examples, reception, by the first wireless device 505, of the symbol allocation for FMCW, the set of FMCW parameters, or both may trigger the first wireless device 505 to perform OFDM channel estimation using the FMCW signals.

At 535, the second wireless device 510 may generate a first FMCW signal for estimation, by the first wireless device 505, of the OFDM channel. In some examples, the first FMCW signal may be generated or configured to support frequency domain OFDM channel estimation. The second wireless device 510 may generate the first FMCW signal as a time domain signal. The second wireless device 510 may generate the first FMCW signal based on some or all of the information conveyed via the first, second, and third control messages. For example, the second wireless device 510 may generate the first FMCW signal based on the set of FMCW parameters indicated via the second control message. In some examples, the second wireless device 510 may generate the first FMCW signal based on (e.g., in response to or after) receiving the capability message from the first wireless device 505, based on transmitting any of the first through third control messages, or any combination thereof.

At 540, the second wireless device 510 may transmit the first FMCW signal to the first wireless device 505 via the OFDM channel. The first wireless device 505 may receive the first FMCW signal as an analog time domain signal via the OFDM channel.

At 545, the first wireless device 505 may generate a second FMCW signal, which may be referred to as a local signal in some examples herein. The first wireless device 505 may generate the second FMCW signal based on the set of FMCW parameters that are associated with the first FMCW signal (e.g., as indicated via the second control message at 525). For example, the first wireless device 505 may generate the second FMCW signal based on a same starting frequency, slope, and bandwidth as the first FMCW signal, as described in further detail elsewhere herein, including with reference to FIG. 3. Generating the second FMCW signal by the first wireless device 505 may be based on one or more configured rules or procedures for FMCW-based OFDM channel estimation. For example, the second FMCW signal may be generated based on an FMCW function configured to support improved OFDM channel estimation.

At 550, the first wireless device 505 may estimate the OFDM channel based on the first and second FMCW signals. To estimate the frequency domain OFDM channel, the first wireless device 505 may, in some examples, combine the first and second FMCW signals to generate a combined FMCW signal. The first wireless device 505 may filter the combined FMCW signal (e.g., using an LPF). The first wireless device 505 may sample, after the filtering, the combined FMCW signal in a time domain using a sampling rate that is based on one or more parameters of the OFDM channel, such as a subband frequency range of the OFDM channel (e.g., f_{subband}). In some examples, the first wireless device 505 may sample the combined FMCW signal using an ADC, as described in further detail elsewhere herein, including with reference to FIG. 3.

The first wireless device 505 may estimate the frequency domain OFDM channel by estimating a respective value of the OFDM channel for each subband of multiple subbands in a frequency domain of the OFDM channel based on the sampling. For example, the sampling may produce a sampling sequence, where each value in the sampling sequence is associated with a respective subband of the OFDM channel. By adjusting the sampling rate used by the first wireless device 505 based on the subband frequency range (e.g., a frequency estimation granularity), the first wireless device 505 may change a quantity of subbands that are estimated (e.g., the first wireless device 505 may make the frequency domain OFDM channel estimation more or less granular). The sampling rate used for sampling the combined and filtered FMCW signal may be relatively low (e.g., less than a sampling rate used to estimate OFDM channels based on OFDM signals), which may reduce processing complexity and power consumption at the device.

At 555, in some examples, the second wireless device 510 may transmit a control message that includes a trigger (e.g., a request) for the first wireless device 505 to transmit a CSI report, or some other report that indicates the OFDM channel estimation. The first wireless device 505 may generate a CSI report based on the CSI report trigger and the OFDM channel estimation based on the FMCW signals. At 560, the first wireless device 505 may transmit the CSI report to the second wireless device 510.

At 565, the second wireless device 510 and the first wireless device 505 may communicate OFDM signals via the OFDM channel based on the estimation of the frequency domain OFDM channel. For example, the second wireless device 510 and the first wireless device 505 may transmit and receive uplink data, downlink data, sidelink data, or any combination thereof, where the data may be conveyed via an OFDM signal. The FMCW-based frequency domain OFDM channel estimation techniques described herein may thereby provide for the first wireless device 505 to reliably and accurately estimate a frequency domain OFDM channel using time domain signal processing and a relatively low sampling rate. By estimating the OFDM channel based on FMCW signals, the first wireless device 505 may improve throughput, communication reliability, and coordination between devices while maintaining or reducing processing complexity, latency, and power consumption.

FIG. 6 illustrates an example of a process flow 600 that supports estimating OFDM channels using FMCWs in accordance with one or more aspects of the present disclosure. The process flow 600 may implement or be implemented by aspects of the wireless communications systems 100 and 400 or the OFDM channel estimation scheme 300. For example, the process flow 600 illustrates communications between a first wireless device 605 and a second wireless device 610, which may represent aspects of corresponding devices as described with reference to FIGS. 1-5. In this example, the first wireless device 605 may represent an example of a network entity 105 and the second wireless device 610 may represent an example of a UE 115. The devices may exchange signaling to support FMCW-based OFDM channel estimation.

In the following description of the process flow 600, the operations between the first wireless device 605 and the second wireless device 610 may be performed in different orders or at different times. Some operations may also be left out of the process flow 600, or other operations may be added. Although the first wireless device 605 and the second wireless device 610 are shown performing the operations of the process flow 600, some aspects of some operations may also be performed by one or more other wireless devices.

At 615, the second wireless device 610 may transmit a capability message to the first wireless device 605. The capability message may indicate whether the second wireless device 610 is capable of transmitting FMCW signals (e.g., an FMCW transmission capability). In some examples, the capability message may indicate whether the second wireless device 610 is capable of transmitting FMCW signals configured for frequency domain OFDM channel estimation.

At 620, the first wireless device 605 may transmit a first control message, which may be referred to as a symbol allocation control message in some aspects herein. The first control message may indicate whether one or more symbols of the OFDM channel are allocated for FMCW signals or OFDM signals. For example, the first control message may include a bitmap or one or more indices configured to allocate a first set of symbols for transmission and reception of OFDM signals and a second set of symbols for transmission and reception of FMCW signals. The OFDM signals and the FMCW signals may be time division multiplexed across the symbols of the OFDM channel. The first wireless device 605 may transmit the first control message dynamically or semi-persistently to the second wireless device 610 to indicate symbol allocations to the second wireless device 610. The first control message may be, for example, a DCI message, a MAC-CE, an RRC message, or any combination thereof. In some examples, the first wireless device 605 may transmit the symbol allocation control message based on (e.g., in response to, after) the capability message from the second wireless device 610.

At 625, the first wireless device 605 may transmit a second control message, which may be referred to as an FMCW parameter control message in some aspects herein. The second control message may indicate a set of FMCW parameters associated with a first FMCW signal to be transmitted by the second wireless device 610. The set of FMCW parameters may include a starting frequency of the first FMCW signal, a bandwidth of the first FMCW signal, a slope of the first FMCW signal, or any combination thereof (e.g., {f_{c}}, {BW}, {S}). The starting frequency, bandwidth, and slope may represent examples of corresponding parameters described with reference to FIG. 3. In some examples, the slope may be based on the bandwidth of the first FMCW signal and a duration of a symbol via which the first FMCW signal is to be transmitted.

As described in further detail with reference to FIG. 4, the second control message may be a DCI message, a MAC-CE, an RRC message, some other type of control signaling, or any combination thereof. The first wireless device 605 may transmit the second control message (e.g., an indication of the FMCW parameters) dynamically or semi-persistently. In some examples, the first wireless device 605 may transmit one or more RRC messages that may each configure (e.g., pre-configure) a set of FMCW parameters, and the second control message may be a DCI message or MAC-CE signaling that indicates, to the second wireless device 610, an index to one of the sets of FMCW signals. Additionally, or alternatively, the first wireless device 605 may transmit a single RRC message that configures multiple sets of FMCW parameters, and the second control message may be a DCI message or MAC-CE signaling that indicates, to the second wireless device 610, an index to one of the sets of FMCW signals.

At 630, the first wireless device 605 may transmit a third control message to the second wireless device 610. The third control message may be referred to as an FMCW transmission trigger in some aspects herein. The FMCW transmission trigger may trigger the second wireless device 610 to transmit an FMCW signal. That is, the FMCW transmission trigger may include a request, instructions, or an indication to trigger the second wireless device 610 to generate and transmit an FMCW signal for estimating a frequency domain OFDM channel.

Although the symbol allocation control message, the FMCW parameter control message, and the FMCW transmission trigger (e.g., the first through third control messages) are illustrated as separate control messages, it is to be understood that the first wireless device 605 may transmit any quantity of control messages to indicate any combination of the described symbol allocations, FMCW parameters, and FMCW transmission trigger. In some examples, the first wireless device 605 may transmit a single control message (e.g., a single DCI, MAC-CE or RRC message) that indicates each of the symbol allocation for FMCW, the set of FMCW parameters, and the FMCW transmission trigger. Additionally, or alternatively, the first wireless device 605 may transmit two control messages, to indicate the symbol allocation for FMCW and the set of FMCW parameters, respectively. In some examples, reception, by the second wireless device 610, of the symbol allocation for FMCW, the set of FMCW parameters, or both may trigger the second wireless device 610 to transmit an FMCW signal for channel estimation (e.g., via the allocated symbols and using the indicated FMCW parameters). In some examples, any one or more of the first through third control messages may be transmitted by the first wireless device 605 based on (e.g., in response to, after) the capability message from the second wireless device 610 indicating that the second wireless device 610 supports FMCW transmission.

At 635, the second wireless device 610 may generate a first FMCW signal for estimation, by the first wireless device 605, of the OFDM channel. In some examples, the first FMCW signal may be generated or configured to support frequency domain OFDM channel estimation. The second wireless device 610 may generate the first FMCW signal as a time domain signal. The second wireless device 610 may generate the first FMCW signal based on some or all of the information conveyed via the first, second, and third control messages. For example, the second wireless device 610 may generate the first FMCW signal based on the set of FMCW parameters received via the second control message. In some examples, the second wireless device 610 may generate the first FMCW signal based on (e.g., in response to or after) transmitting the capability message, based on receiving any of the first through third control messages, or any combination thereof.

At 640, the second wireless device 610 may transmit the first FMCW signal to the first wireless device 605 via the OFDM channel. The first wireless device 605 may receive the first FMCW signal as an analog time domain signal via the OFDM channel.

At 645, the first wireless device 605 may generate a second FMCW signal, which may be referred to as a local signal in some examples herein. The first wireless device 605 may generate the second FMCW signal based on the set of FMCW parameters that are associated with the first FMCW signal (e.g., as indicated via the second control message at 625). For example, the first wireless device 605 may generate the second FMCW signal based on a same starting frequency, slope, and bandwidth as the first FMCW signal, as described in further detail elsewhere herein, including with reference to FIG. 3. Generating the second FMCW signal by the first wireless device 605 may be based on one or more configured rules or procedures for FMCW-based OFDM channel estimation. For example, the second FMCW signal may be generated based on an FMCW function configured to support improved OFDM channel estimation.

At 650, the first wireless device 605 may estimate the OFDM channel based on the first and second FMCW signals. To estimate the frequency domain OFDM channel, the first wireless device 605 may, in some examples, combine the first and second FMCW signals to generate a combined FMCW signal. The first wireless device 605 may filter the combined FMCW signal (e.g., using an LPF). The first wireless device 605 may sample, after the filtering, the combined FMCW signal in a time domain using a sampling rate that is based on one or more parameters of the OFDM channel, such as a subband frequency range or size of the OFDM channel (e.g., f_{subband}). In some examples, the first wireless device 605 may sample the combined FMCW signal using an ADC, as described in further detail elsewhere herein, including with reference to FIG. 3.

The first wireless device 605 may estimate the frequency domain OFDM channel by estimating a respective value of the OFDM channel for each subband of multiple subbands in a frequency domain of the OFDM channel based on the sampling. For example, the sampling may produce a sampling sequence, where each value in the sampling sequence is associated with a respective subband of the OFDM channel. By adjusting the sampling rate used by the first wireless device 605 based on the subband frequency range (e.g., a frequency estimation granularity), the first wireless device 605 may change a quantity of subbands that are estimated (e.g., the first wireless device 605 may make the frequency domain OFDM channel estimation more or less granular). The sampling rate used for sampling the combined and filtered FMCW signal may be relatively low (e.g., less than a sampling rate used to estimate OFDM channels based on OFDM signals), which may reduce processing complexity and power consumption at the device.

At 655, the first wireless device 605 and the second wireless device 610 and may communicate OFDM signals via the OFDM channel based on the estimation of the frequency domain OFDM channel. For example, the first wireless device 605 may transmit one or more follow-up data transmissions to the second wireless device 610 after estimating the frequency domain OFDM channel. The follow-up data transmissions may be OFDM signals that indicate the channel estimation or other information associated with the estimation of the frequency domain OFDM channel. The first wireless device 605 and the second wireless device 610 may transmit and receive uplink data, downlink data, sidelink data, or any combination thereof, where the data may be conveyed via an OFDM signal.

The FMCW-based frequency domain OFDM channel estimation techniques described herein may thereby provide for the first wireless device 605 to reliably and accurately estimate a frequency domain OFDM channel using time domain signal processing and a relatively low sampling rate. By estimating the OFDM channel based on FMCW signals, the first wireless device 605 may improve throughput, communication reliability, and coordination between devices while maintaining or reducing processing complexity, latency, and power consumption.

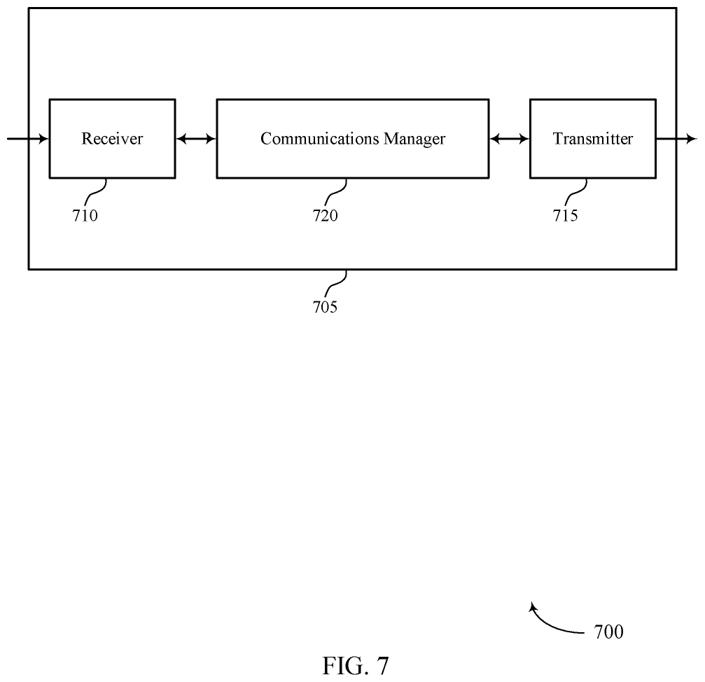

FIG. 7 illustrates a block diagram 700 of a device 705 that supports estimating OFDM channels using FMCWs in accordance with one or more aspects of the present disclosure. The device 705 may be an example of aspects of a UE 115 or a network entity 105 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to estimating OFDM channels using FMCWs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to estimating OFDM channels using FMCWs). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of estimating OFDM channels using FMCWs as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first wireless device in accordance with examples as disclosed herein. For example, the communications manager 720 may be configured as or otherwise support a means for receiving a first FMCW signal via an OFDM channel. The communications manager 720 may be configured as or otherwise support a means for generating a second FMCW signal based on a set of FMCW parameters that are associated with the first FMCW signal. The communications manager 720 may be configured as or otherwise support a means for estimating the OFDM channel based on samples of a combined FMCW signal in a time domain, the combined FMCW signal including a combination of the first FMCW signal and the second FMCW signal.

Additionally, or alternatively, the communications manager 720 may support wireless communication at a second wireless device in accordance with examples as disclosed herein. For example, the communications manager 720 may be configured as or otherwise support a means for generating an FMCW signal, the FMCW signal for estimation, by a first wireless device, of an OFDM channel. The communications manager 720 may be configured as or otherwise support a means for transmitting the FMCW signal via the OFDM channel. The communications manager 720 may be configured as or otherwise support a means for communicating OFDM signals with the first wireless device via the OFDM channel based on the estimation of the OFDM channel.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reduced processing, reduced power consumption, and more efficient utilization of communication resources.

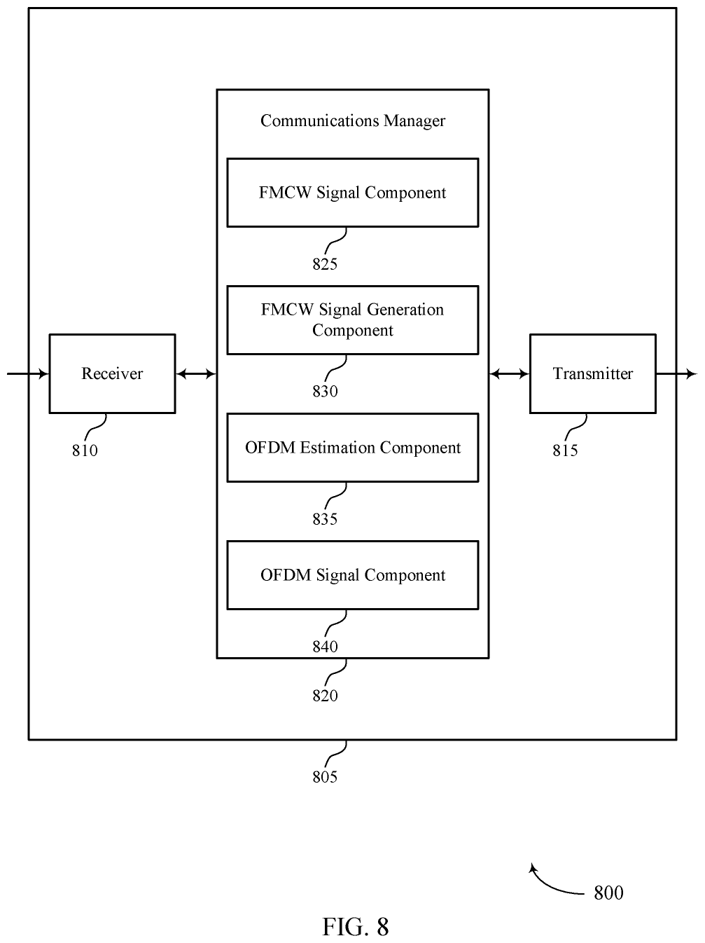

FIG. 8 illustrates a block diagram 800 of a device 805 that supports estimating OFDM channels using FMCWs in accordance with one or more aspects of the present disclosure. The device 805 may be an example of aspects of a device 705, a UE 115, or a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to estimating OFDM channels using FMCWs). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to estimating OFDM channels using FMCWs). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of estimating OFDM channels using FMCWs as described herein. For example, the communications manager 820 may include an FMCW signal component 825, an FMCW signal generation component 830, an OFDM estimation component 835, an OFDM signal component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a first wireless device in accordance with examples as disclosed herein. The FMCW signal component 825 may be configured as or otherwise support a means for receiving a first FMCW signal via an OFDM channel. The FMCW signal generation component 830 may be configured as or otherwise support a means for generating a second FMCW signal based on a set of FMCW parameters that are associated with the first FMCW signal. The OFDM estimation component 835 may be configured as or otherwise support a means for estimating the OFDM channel based on samples of a combined FMCW signal in a time domain, the combined FMCW signal including a combination of the first FMCW signal and the second FMCW signal.

Additionally, or alternatively, the communications manager 820 may support wireless communication at a second wireless device in accordance with examples as disclosed herein. The FMCW signal generation component 830 may be configured as or otherwise support a means for generating an FMCW signal, the FMCW signal for estimation, by a first wireless device, of an OFDM channel. The FMCW signal component 825 may be configured as or otherwise support a means for transmitting the FMCW signal via the OFDM channel. The OFDM signal component 840 may be configured as or otherwise support a means for communicating OFDM signals with the first wireless device via the OFDM channel based on the estimation of the OFDM channel.

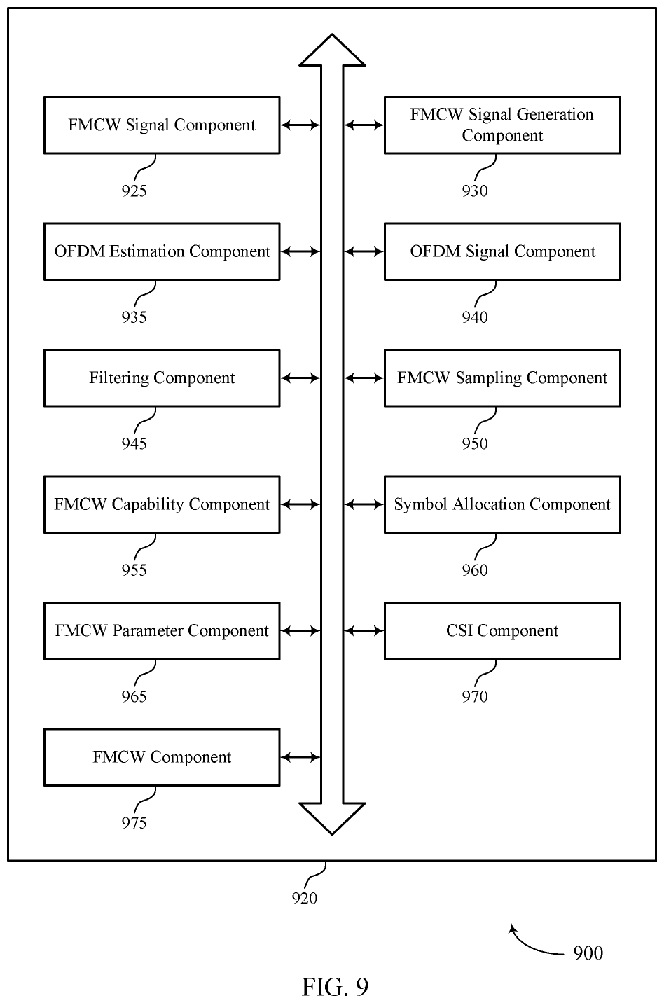

FIG. 9 illustrates a block diagram 900 of a communications manager 920 that supports estimating OFDM channels using FMCWs in accordance with one or more aspects of the present disclosure. The communications manager 920 may be an example of aspects of a communications manager 720, a communications manager 820, or both, as described herein. The communications manager 920, or various components thereof, may be an example of means for performing various aspects of estimating OFDM channels using FMCWs as described herein. For example, the communications manager 920 may include an FMCW signal component 925, an FMCW signal generation component 930, an OFDM estimation component 935, an OFDM signal component 940, a filtering component 945, an FMCW sampling component 950, an FMCW capability component 955, a symbol allocation component 960, an FMCW parameter component 965, a CSI component 970, an FMCW component 975, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 920 may support wireless communication at a first wireless device in accordance with examples as disclosed herein. The FMCW signal component 925 may be configured as or otherwise support a means for receiving a first FMCW signal via an OFDM channel. The FMCW signal generation component 930 may be configured as or otherwise support a means for generating a second FMCW signal based on a set of FMCW parameters that are associated with the first FMCW signal. The OFDM estimation component 935 may be configured as or otherwise support a means for estimating the OFDM channel based on samples of a combined FMCW signal in a time domain, the combined FMCW signal including a combination of the first FMCW signal and the second FMCW signal.

In some examples, to support estimating the OFDM channel, the filtering component 945 may be configured as or otherwise support a means for filtering the combined FMCW signal. In some examples, to support estimating the OFDM channel, the FMCW sampling component 950 may be configured as or otherwise support a means for sampling, after the filtering, the combined FMCW signal in the time domain using a sampling rate that is based on a subband frequency range of the OFDM channel, where the estimating includes estimating a respective value of the OFDM channel for each subband of a set of multiple subbands in a frequency domain of the OFDM channel based on the sampling.

In some examples, the OFDM signal component 940 may be configured as or otherwise support a means for receiving one or more OFDM signals time division multiplexed with the first FMCW signal within the OFDM channel.

In some examples, the FMCW capability component 955 may be configured as or otherwise support a means for transmitting a capability message that indicates the first wireless device is capable of estimating the OFDM channel using time domain FMCW signals, where the first wireless device includes a UE. In some examples, the FMCW capability component 955 may be configured as or otherwise support a means for receiving a capability message that indicates a second wireless device is capable of transmitting FMCW signals for OFDM channel estimation, where the first wireless device includes a network entity.

In some examples, the symbol allocation component 960 may be configured as or otherwise support a means for receiving a control message that indicates whether one or more symbols of the OFDM channel are allocated for FMCW signals, where the first FMCW signal is received within a symbol of the one or more symbols that is indicated as allocated for the FMCW signals, and where the first wireless device includes a UE.

In some examples, the symbol allocation component 960 may be configured as or otherwise support a means for transmitting a control message that indicates whether one or more symbols of the OFDM channel are allocated for FMCW signals or for OFDM signals, where the first FMCW signal is received within a symbol of the one or more symbols that is allocated for the FMCW signals based on the control message, and where the first wireless device includes a network entity.

In some examples, the FMCW parameter component 965 may be configured as or otherwise support a means for receiving a control message that indicates the set of FMCW parameters, the set of FMCW parameters including a starting frequency of the first FMCW signal, a bandwidth of the first FMCW signal, a slope of the first FMCW signal, or any combination thereof, where the slope is based on the bandwidth of the first FMCW signal and a duration of a symbol via which the first FMCW signal is received.

In some examples, the FMCW parameter component 965 may be configured as or otherwise support a means for transmitting a control message that indicates the set of FMCW parameters, the set of FMCW parameters including a starting frequency of the first FMCW signal, a bandwidth of the first FMCW signal, a slope of the first FMCW signal, or any combination thereof, where the slope is based on the bandwidth of the first FMCW signal and a duration of a symbol via which the first FMCW signal is received, and where receiving the first FMCW signal is based on the set of FMCW parameters.

In some examples, the OFDM estimation component 935 may be configured as or otherwise support a means for receiving a control message including a trigger for the first wireless device to perform OFDM channel estimation using FMCW signals, where using the first FMCW signal and the second FMCW signal to estimate the OFDM channel is based on the trigger, and where the first wireless device includes a UE.

In some examples, the CSI component 970 may be configured as or otherwise support a means for receiving a control message including a trigger for the first wireless device to transmit a channel state information report based on the first FMCW signal. In some examples, the CSI component 970 may be configured as or otherwise support a means for transmitting the channel state information report including a set of channel state information parameters based on receiving the trigger and estimating the OFDM channel.

In some examples, the FMCW signal component 925 may be configured as or otherwise support a means for transmitting a control message including a trigger for a second wireless device to transmit the first FMCW signal. In some examples, the first wireless device includes a UE or a network entity.

Additionally, or alternatively, the communications manager 920 may support wireless communication at a second wireless device in accordance with examples as disclosed herein. In some examples, the FMCW signal generation component 930 may be configured as or otherwise support a means for generating an FMCW signal, the FMCW signal for estimation, by a first wireless device, of an OFDM channel. In some examples, the FMCW signal component 925 may be configured as or otherwise support a means for transmitting the FMCW signal via the OFDM channel. The OFDM signal component 940 may be configured as or otherwise support a means for communicating OFDM signals with the first wireless device via the OFDM channel based on the estimation of the OFDM channel.

In some examples, the OFDM signal component 940 may be configured as or otherwise support a means for transmitting one or more OFDM signals time division multiplexed with the FMCW signal within the OFDM channel.

In some examples, the FMCW capability component 955 may be configured as or otherwise support a means for transmitting a capability message that indicates the second wireless device is capable of transmitting FMCW signals for OFDM channel estimation, where the second wireless device includes a UE.

In some examples, the FMCW capability component 955 may be configured as or otherwise support a means for receiving a capability message that indicates the first wireless device is capable of estimating the OFDM channel using time domain FMCW signals, where the second wireless device includes a network entity.

In some examples, the symbol allocation component 960 may be configured as or otherwise support a means for receiving a control message that indicates whether one or more symbols of the OFDM channel is allocated for FMCW signals, where the FMCW signal is transmitted within a symbol of the one or more symbols that is allocated for the FMCW signals based on the control message, and where the second wireless device includes a UE.

In some examples, the symbol allocation component 960 may be configured as or otherwise support a means for transmitting a control message that indicates whether one or more symbols of the OFDM channel are allocated for FMCW signals or for OFDM signals, where the FMCW signal is transmitted within a symbol of the one or more symbols that are allocated for the FMCW signals, and where the second wireless device includes a network entity.

In some examples, the FMCW parameter component 965 may be configured as or otherwise support a means for receiving a control message that indicates a set of FMCW parameters that are associated with the FMCW signal, the set of FMCW parameters including a starting frequency of the FMCW signal, a bandwidth of the FMCW signal, a slope of the FMCW signal, or any combination thereof, where the slope is based on the bandwidth of the FMCW signal and a duration of a symbol via which the FMCW signal is transmitted, and where transmitting the FMCW signal is based on the set of FMCW parameters.

In some examples, the FMCW parameter component 965 may be configured as or otherwise support a means for transmitting a control message that indicates a set of FMCW parameters that are associated with the FMCW signal, the set of FMCW parameters including a starting frequency of the FMCW signal, a bandwidth of the FMCW signal, a slope of the FMCW signal, or any combination thereof, where the slope is based on the bandwidth of the FMCW signal and a duration of a symbol via which the FMCW signal is transmitted, and where the estimation of the OFDM channel is based on the set of FMCW parameters.

In some examples, the OFDM estimation component 935 may be configured as or otherwise support a means for transmitting a control message including a trigger for the first wireless device to perform OFDM channel estimation using FMCW signals, where the estimation of the OFDM channel is based on the trigger, and where the second wireless device includes a network entity.

In some examples, the CSI component 970 may be configured as or otherwise support a means for transmitting a control message including a trigger for the first wireless device to transmit a channel state information report that is based on the FMCW signal. In some examples, the CSI component 970 may be configured as or otherwise support a means for receiving, based at least in part on the trigger, the channel state information report including a set of channel state information parameters.

In some examples, the FMCW component 975 may be configured as or otherwise support a means for receiving a control message including a trigger for the second wireless device to transmit the FMCW signal, where transmitting the FMCW signal is based on the trigger.

In some examples, the second wireless device includes a UE or a network entity.

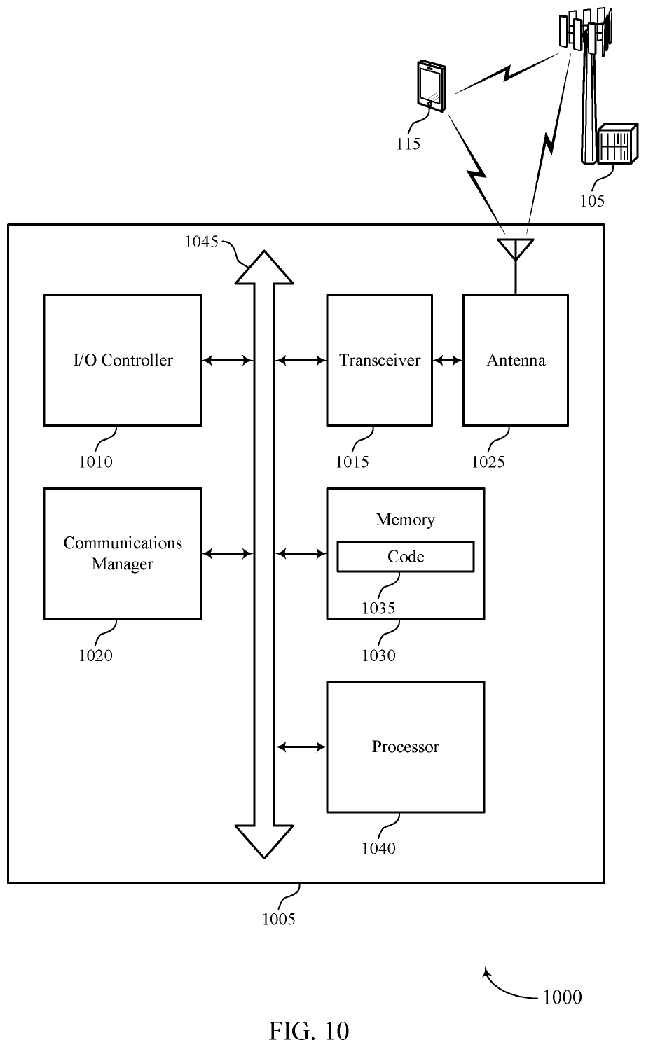

FIG. 10 illustrates a diagram of a system 1000 including a device 1005 that supports estimating OFDM channels using FMCWs in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting estimating OFDM channels using FMCWs). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a first wireless device in accordance with examples as disclosed herein. For example, the communications manager 1020 may be configured as or otherwise support a means for receiving a first FMCW signal via an OFDM channel. The communications manager 1020 may be configured as or otherwise support a means for generating a second FMCW signal based on a set of FMCW parameters that are associated with the first FMCW signal. The communications manager 1020 may be configured as or otherwise support a means for estimating the OFDM channel based on samples of a combined FMCW signal in a time domain, the combined FMCW signal including a combination of the first FMCW signal and the second FMCW signal.

Additionally, or alternatively, the communications manager 1020 may support wireless communication at a second wireless device in accordance with examples as disclosed herein. For example, the communications manager 1020 may be configured as or otherwise support a means for generating an FMCW signal, the FMCW signal for estimation, by a first wireless device, of an OFDM channel. The communications manager 1020 may be configured as or otherwise support a means for transmitting the FMCW signal via the OFDM channel. The communications manager 1020 may be configured as or otherwise support a means for communicating OFDM signals with the first wireless device via the OFDM channel based on the estimation of the OFDM channel.

By including or configuring the communications manager 1020 in accordance with examples as described herein, the device 1005 may support techniques for improved communication reliability, reduced latency, improved user experience related to reduced processing, reduced power consumption, more efficient utilization of communication resources, improved coordination between devices, and longer battery life.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of estimating OFDM channels using FMCWs as described herein, or the processor 1040 and the memory 1030 may be otherwise configured to perform or support such operations.

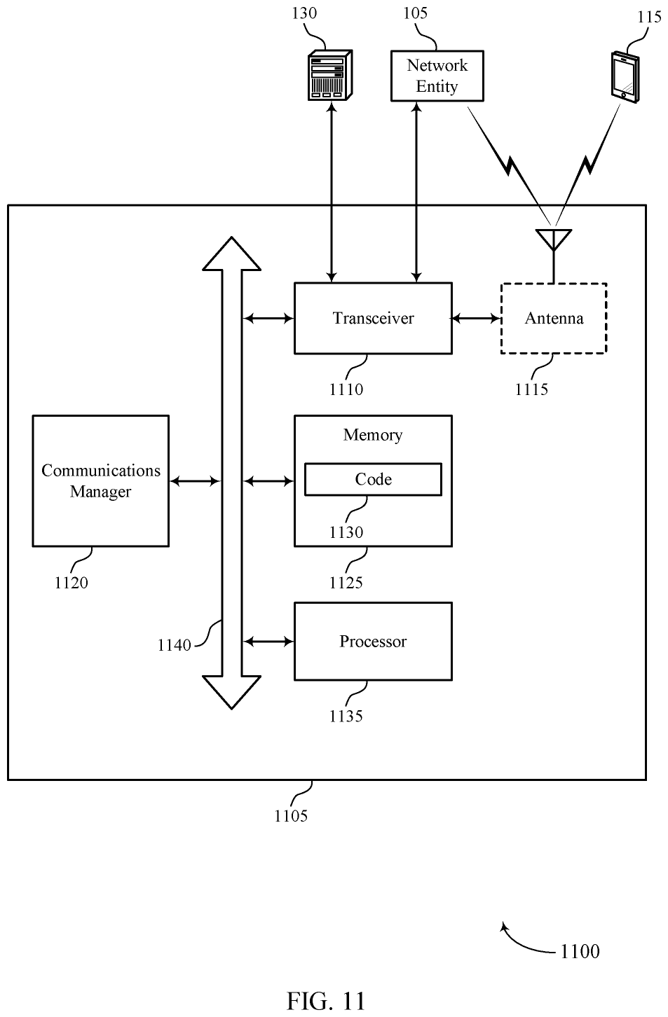

FIG. 11 illustrates a diagram of a system 1100 including a device 1105 that supports estimating OFDM channels using FMCWs in accordance with one or more aspects of the present disclosure. The device 1105 may be an example of or include the components of a device 705, a device 805, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting estimating OFDM channels using FMCWs). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communication at a first wireless device in accordance with examples as disclosed herein. For example, the communications manager 1120 may be configured as or otherwise support a means for receiving a first FMCW signal via an OFDM channel. The communications manager 1120 may be configured as or otherwise support a means for generating a second FMCW signal based on a set of FMCW parameters that are associated with the first FMCW signal. The communications manager 1120 may be configured as or otherwise support a means for estimating the OFDM channel based on samples of a combined FMCW signal in a time domain, the combined FMCW signal including a combination of the first FMCW signal and the second FMCW signal.

Additionally, or alternatively, the communications manager 1120 may support wireless communication at a second wireless device in accordance with examples as disclosed herein. For example, the communications manager 1120 may be configured as or otherwise support a means for generating an FMCW signal, the FMCW signal for estimation, by a first wireless device, of an OFDM channel. The communications manager 1120 may be configured as or otherwise support a means for transmitting the FMCW signal via the OFDM channel. The communications manager 1120 may be configured as or otherwise support a means for communicating OFDM signals with the first wireless device via the OFDM channel based on the estimation of the OFDM channel.

By including or configuring the communications manager 1120 in accordance with examples as described herein, the device 1105 may support techniques for improved communication reliability, reduced latency, improved user experience related to reduced processing, reduced power consumption, more efficient utilization of communication resources, and improved coordination between devices.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of estimating OFDM channels using FMCWs as described herein, or the processor 1135 and the memory 1125 may be otherwise configured to perform or support such operations.

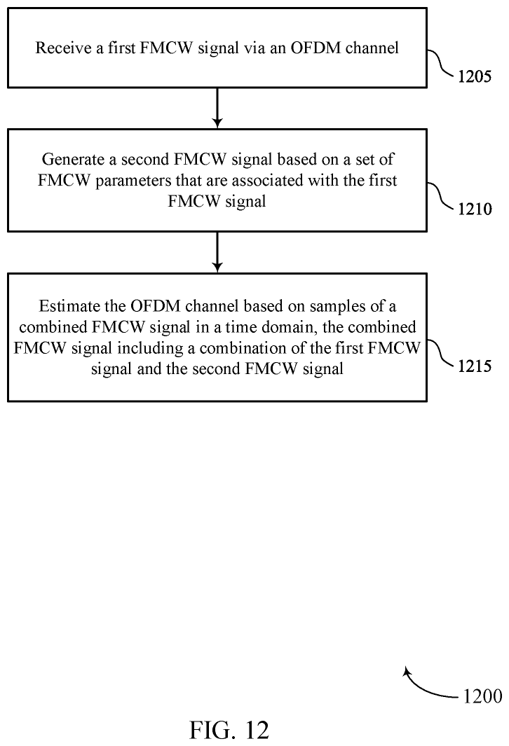

FIG. 12 illustrates a flowchart illustrating a method 1200 that supports estimating OFDM channels using FMCWs in accordance with one or more aspects of the present disclosure. The operations of the method 1200 may be implemented by a UE or a network entity or its components as described herein. For example, the operations of the method 1200 may be performed by a UE 115 or a network entity as described with reference to FIGS. 1 through 11. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1205, the method may include receiving a first FMCW signal via an OFDM channel. The operations of 1205 may be performed in accordance with examples as disclosed herein. In some examples, aspects of the operations of 1205 may be performed by an FMCW signal component 925 as described with reference to FIG. 9.

At 1210, the method may include generating a second FMCW signal based on a set of FMCW parameters that are associated with the first FMCW signal. The operations of 1210 may be performed in accordance with examples as disclosed herein. In some examples, aspects of the operations of 1210 may be performed by an FMCW signal generation component 930 as described with reference to FIG. 9.

At 1215, the method may include estimating the OFDM channel based on samples of a combined FMCW signal in a time domain, the combined FMCW signal including a combination of the first FMCW signal and the second FMCW signal. The operations of 1215 may be performed in accordance with examples as disclosed herein. In some examples, aspects of the operations of 1215 may be performed by an OFDM estimation component 935 as described with reference to FIG. 9.

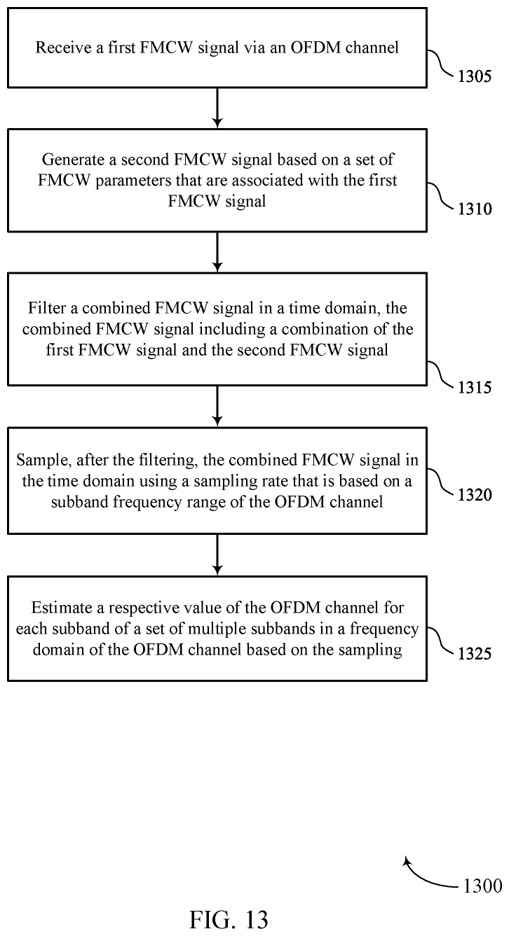

FIG. 13 illustrates a flowchart illustrating a method 1300 that supports estimating OFDM channels using FMCWs in accordance with one or more aspects of the present disclosure. The operations of the method 1300 may be implemented by a UE or a network entity or its components as described herein. For example, the operations of the method 1300 may be performed by a UE 115 or a network entity as described with reference to FIGS. 1 through 11. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1305, the method may include receiving a first FMCW signal via an OFDM channel. The operations of 1305 may be performed in accordance with examples as disclosed herein. In some examples, aspects of the operations of 1305 may be performed by an FMCW signal component 925 as described with reference to FIG. 9.

At 1310, the method may include generating a second FMCW signal based on a set of FMCW parameters that are associated with the first FMCW signal. The operations of 1310 may be performed in accordance with examples as disclosed herein. In some examples, aspects of the operations of 1310 may be performed by an FMCW signal generation component 930 as described with reference to FIG. 9.

At 1315, the method may include filtering a combined FMCW signal in a time domain, the combined FMCW signal including a combination of the first FMCW signal and the second FMCW signal. The operations of 1315 may be performed in accordance with examples as disclosed herein. In some examples, aspects of the operations of 1315 may be performed by a filtering component 945 as described with reference to FIG. 9.

At 1320, the method may include sampling, after the filtering, the combined FMCW signal in the time domain using a sampling rate that is based on a subband frequency range of the OFDM channel. The operations of 1320 may be performed in accordance with examples as disclosed herein. In some examples, aspects of the operations of 1320 may be performed by an FMCW sampling component 950 as described with reference to FIG. 9.

At 1325, the method may include estimating a respective value of the OFDM channel for each subband of a set of multiple subbands in a frequency domain of the OFDM channel based on the sampling. The operations of 1325 may be performed in accordance with examples as disclosed herein. In some examples, aspects of the operations of 1325 may be performed by an OFDM estimation component 935 as described with reference to FIG. 9.

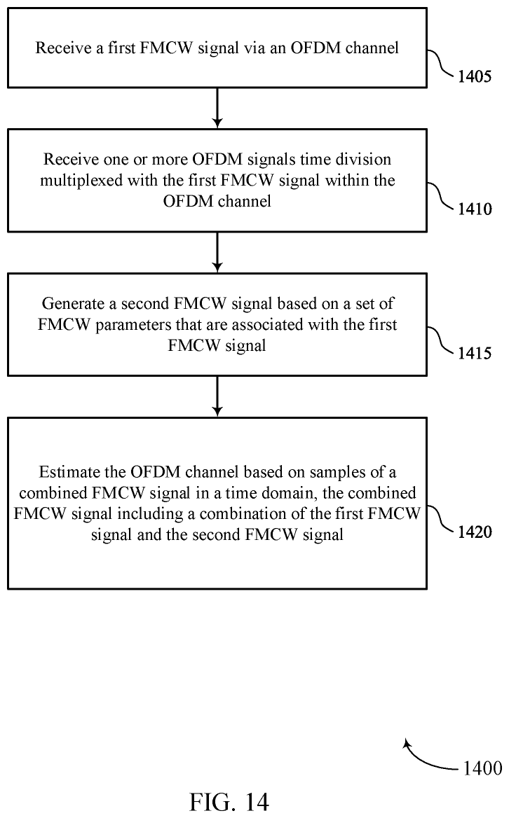

FIG. 14 illustrates a flowchart illustrating a method 1400 that supports estimating OFDM channels using FMCWs in accordance with one or more aspects of the present disclosure. The operations of the method 1400 may be implemented by a UE or a network entity or its components as described herein. For example, the operations of the method 1400 may be performed by a UE 115 or a network entity as described with reference to FIGS. 1 through 11. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1405, the method may include receiving a first FMCW signal via an OFDM channel. The operations of 1405 may be performed in accordance with examples as disclosed herein. In some examples, aspects of the operations of 1405 may be performed by an FMCW signal component 925 as described with reference to FIG. 9.

At 1410, the method may include receiving one or more OFDM signals time division multiplexed with the first FMCW signal within the OFDM channel. The operations of 1410 may be performed in accordance with examples as disclosed herein. In some examples, aspects of the operations of 1410 may be performed by an OFDM signal component 940 as described with reference to FIG. 9.

At 1415, the method may include generating a second FMCW signal based on a set of FMCW parameters that are associated with the first FMCW signal. The operations of 1415 may be performed in accordance with examples as disclosed herein. In some examples, aspects of the operations of 1415 may be performed by an FMCW signal generation component 930 as described with reference to FIG. 9.

At 1420, the method may include estimating the OFDM channel based on samples of a combined FMCW signal in a time domain, the combined FMCW signal including a combination of the first FMCW signal and the second FMCW signal. The operations of 1420 may be performed in accordance with examples as disclosed herein. In some examples, aspects of the operations of 1420 may be performed by an OFDM estimation component 935 as described with reference to FIG. 9.

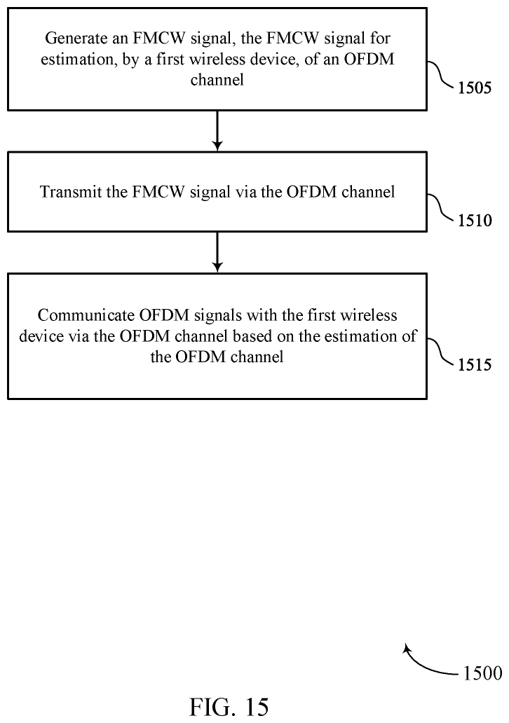

FIG. 15 illustrates a flowchart illustrating a method 1500 that supports estimating OFDM channels using FMCWs in accordance with one or more aspects of the present disclosure. The operations of the method 1500 may be implemented by a UE or a network entity or its components as described herein. For example, the operations of the method 1500 may be performed by a UE 115 or a network entity as described with reference to FIGS. 1 through 11. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1505, the method may include generating an FMCW signal, the FMCW signal for estimation, by a first wireless device, of an OFDM channel. The operations of 1505 may be performed in accordance with examples as disclosed herein. In some examples, aspects of the operations of 1505 may be performed by an FMCW signal generation component 930 as described with reference to FIG. 9.

At 1510, the method may include transmitting the FMCW signal via the OFDM channel. The operations of 1510 may be performed in accordance with examples as disclosed herein. In some examples, aspects of the operations of 1510 may be performed by an FMCW signal component 925 as described with reference to FIG. 9.

At 1515, the method may include communicating OFDM signals with the first wireless device via the OFDM channel based on the estimation of the OFDM channel. The operations of 1515 may be performed in accordance with examples as disclosed herein. In some examples, aspects of the operations of 1515 may be performed by an OFDM signal component 940 as described with reference to FIG. 9.

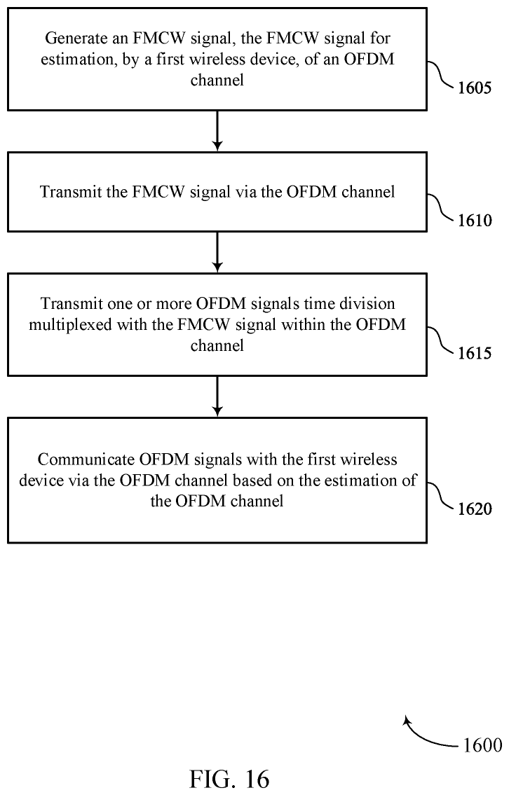

FIG. 16 illustrates a flowchart illustrating a method 1600 that supports estimating OFDM channels using FMCWs in accordance with one or more aspects of the present disclosure. The operations of the method 1600 may be implemented by a UE or a network entity or its components as described herein. For example, the operations of the method 1600 may be performed by a UE 115 or a network entity as described with reference to FIGS. 1 through 11. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1605, the method may include generating an FMCW signal, the FMCW signal for estimation, by a first wireless device, of an OFDM channel. The operations of 1605 may be performed in accordance with examples as disclosed herein. In some examples, aspects of the operations of 1605 may be performed by an FMCW signal generation component 930 as described with reference to FIG. 9.

At 1610, the method may include transmitting the FMCW signal via the OFDM channel. The operations of 1610 may be performed in accordance with examples as disclosed herein. In some examples, aspects of the operations of 1610 may be performed by an FMCW signal component 925 as described with reference to FIG. 9.

At 1615, the method may include transmitting one or more OFDM signals time division multiplexed with the FMCW signal within the OFDM channel. The operations of 1615 may be performed in accordance with examples as disclosed herein. In some examples, aspects of the operations of 1615 may be performed by an OFDM signal component 940 as described with reference to FIG. 9.

At 1620, the method may include communicating OFDM signals with the first wireless device via the OFDM channel based on the estimation of the OFDM channel. The operations of 1620 may be performed in accordance with examples as disclosed herein. In some examples, aspects of the operations of 1620 may be performed by an OFDM signal component 940 as described with reference to FIG. 9.

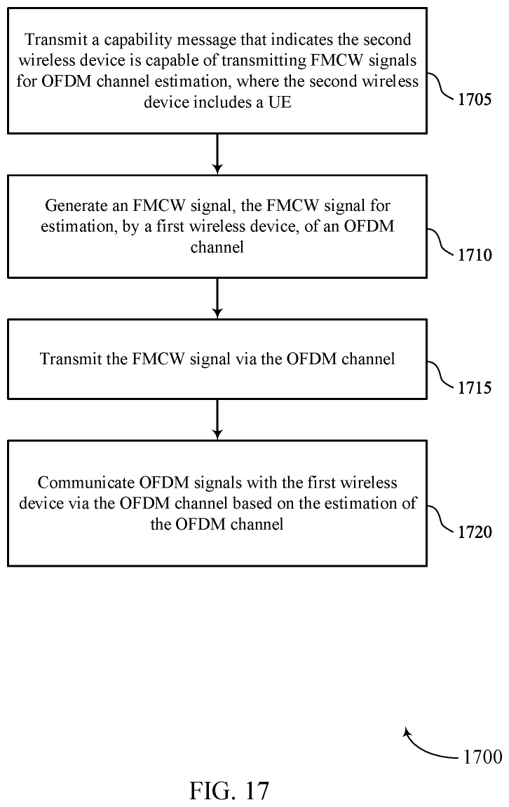

FIG. 17 illustrates a flowchart illustrating a method 1700 that supports estimating OFDM channels using FMCWs in accordance with one or more aspects of the present disclosure. The operations of the method 1700 may be implemented by a UE or a network entity or its components as described herein. For example, the operations of the method 1700 may be performed by a UE 115 or a network entity as described with reference to FIGS. 1 through 11. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1705, the method may include transmitting a capability message that indicates the second wireless device is capable of transmitting FMCW signals for OFDM channel estimation, where the second wireless device includes a UE. The operations of 1705 may be performed in accordance with examples as disclosed herein. In some examples, aspects of the operations of 1705 may be performed by an FMCW capability component 955 as described with reference to FIG. 9.

At 1710, the method may include generating an FMCW signal, the FMCW signal for estimation, by a first wireless device, of an OFDM channel. The operations of 1710 may be performed in accordance with examples as disclosed herein. In some examples, aspects of the operations of 1710 may be performed by an FMCW signal generation component 930 as described with reference to FIG. 9.

At 1715, the method may include transmitting the FMCW signal via the OFDM channel. The operations of 1715 may be performed in accordance with examples as disclosed herein. In some examples, aspects of the operations of 1715 may be performed by an FMCW signal component 925 as described with reference to FIG. 9.

At 1720, the method may include communicating OFDM signals with the first wireless device via the OFDM channel based on the estimation of the OFDM channel. The operations of 1720 may be performed in accordance with examples as disclosed herein. In some examples, aspects of the operations of 1720 may be performed by an OFDM signal component 940 as described with reference to FIG. 9.

The following provides an overview of aspects of the present disclosure:

Aspect 1: A method for wireless communication at a first wireless device, comprising: receiving a first FMCW signal via an OFDM channel; generating a second FMCW signal based at least in part on a set of FMCW parameters that are associated with the first FMCW signal; and estimating the OFDM channel based at least in part on samples of a combined FMCW signal in a time domain, the combined FMCW signal comprising a combination of the first FMCW signal and the second FMCW signal.

Aspect 2: The method of aspect 1, wherein estimating the OFDM channel comprises: filtering the combined FMCW signal; and sampling, after the filtering, the combined FMCW signal in the time domain using a sampling rate that is based at least in part on a subband frequency range of the OFDM channel, wherein the estimating comprises estimating a respective value of the OFDM channel for each subband of a plurality of subbands in a frequency domain of the OFDM channel based at least in part on the sampling.

Aspect 3: The method of any of aspects 1 through 2, further comprising: receiving one or more OFDM signals time division multiplexed with the first FMCW signal within the OFDM channel.

Aspect 4: The method of any of aspects 1 through 3, further comprising: transmitting a capability message that indicates the first wireless device is capable of estimating the OFDM channel using time domain FMCW signals, wherein the first wireless device comprises a UE.

Aspect 5: The method of any of aspects 1 through 3, further comprising: receiving a capability message that indicates a second wireless device is capable of transmitting FMCW signals for OFDM channel estimation, wherein the first wireless device comprises a network entity.

Aspect 6: The method of any of aspects 1 through 4, further comprising: receiving a control message that indicates whether one or more symbols of the OFDM channel are allocated for FMCW signals, wherein the first FMCW signal is received within a symbol of the set of one or more symbols that is indicated as allocated for the FMCW signals, and wherein the first wireless device comprises a UE.

Aspect 7: The method of any of aspects 1 through 3 and 5, further comprising: transmitting a control message that indicates whether one or more symbols of the OFDM channel are allocated for FMCW signals or for OFDM signals, wherein the first FMCW signal is received within a symbol of the set of one or more symbols that is allocated for the FMCW signals based at least in part on the control message, and wherein the first wireless device comprises a network entity.

Aspect 8: The method of any of aspects 1 through 4 and 6, further comprising: receiving a control message that indicates the set of FMCW parameters, the set of FMCW parameters comprising a starting frequency of the first FMCW signal, a bandwidth of the first FMCW signal, a slope of the first FMCW signal, or any combination thereof, wherein the slope is based at least in part on the bandwidth of the first FMCW signal and a duration of a symbol via which the first FMCW signal is received.

Aspect 9: The method of any of aspects 1 through 3, 5, and 7, further comprising: transmitting a control message that indicates the set of FMCW parameters, the set of FMCW parameters comprising a starting frequency of the first FMCW signal, a bandwidth of the first FMCW signal, a slope of the first FMCW signal, or any combination thereof, wherein the slope is based at least in part on the bandwidth of the first FMCW signal and a duration of a symbol via which the first FMCW signal is received, and wherein receiving the first FMCW signal is based at least in part on the set of FMCW parameters.

Aspect 10: The method of any of aspects 1 through 4, 6, and 8, further comprising: receiving a control message comprising a trigger for the first wireless device to perform OFDM channel estimation using FMCW signals, wherein using the first FMCW signal and the second FMCW signal to estimate the OFDM channel is based at least in part on the trigger, and wherein the first wireless device comprises a UE.

Aspect 11: The method of any of aspects 1 through 4, 6, 8, and 10, further comprising: receiving a control message comprising a trigger for the first wireless device to transmit a CSI report based at least in part on the first FMCW signal; and transmitting the CSI report comprising a set of CSI parameters based at least in part on receiving the trigger and estimating the OFDM channel.

Aspect 12: The method of any of aspects 1 through 3, 5, 7, and 9, further comprising: transmitting a control message comprising a trigger for a second wireless device to transmit the first FMCW signal.

Aspect 13: The method of any of aspects 1 through 12, wherein the first wireless device comprises a UE or a network entity.

Aspect 14: A method for wireless communication at a second wireless device, comprising: generating a FMCW signal, the FMCW signal for estimation, by a first wireless device, of an OFDM channel; transmitting the FMCW signal via the OFDM channel; and communicating OFDM signals with the first wireless device via the OFDM channel based at least in part on the estimation of the OFDM channel.

Aspect 15: The method of aspect 14, further comprising: transmitting one or more OFDM signals time division multiplexed with the FMCW signal within the OFDM channel.

Aspect 16: The method of any of aspects 14 through 15, further comprising: transmitting a capability message that indicates the second wireless device is capable of transmitting FMCW signals for OFDM channel estimation, wherein the second wireless device comprises a UE.

Aspect 17: The method of any of aspects 14 through 15, further comprising: receiving a capability message that indicates the first wireless device is capable of estimating the OFDM channel using time domain FMCW signals, wherein the second wireless device comprises a network entity.

Aspect 18: The method of any of aspects 14 through 16, further comprising: receiving a control message that indicates whether one or more symbols of the OFDM channel is allocated for FMCW signals, wherein the FMCW signal is transmitted within a symbol of the set of one or more symbols that is allocated for the FMCW signals based at least in part on the control message, and wherein the second wireless device comprises a UE.

Aspect 19: The method of any of aspects 14, 15 and 17, further comprising: transmitting a control message that indicates whether one or more symbols of the OFDM channel are allocated for FMCW signals or for OFDM signals, wherein the FMCW signal is transmitted within a symbol of the one or more symbols that are allocated for the FMCW signals, and wherein the second wireless device comprises a network entity.

Aspect 20: The method of any of aspects 14, 16, and 18, further comprising: receiving a control message that indicates a set of FMCW parameters that are associated with the FMCW signal, the set of FMCW parameters comprising a starting frequency of the FMCW signal, a bandwidth of the FMCW signal, a slope of the FMCW signal, or any combination thereof, wherein the slope is based at least in part on the bandwidth of the FMCW signal and a duration of a symbol via which the FMCW signal is transmitted, and wherein transmitting the FMCW signal is based at least in part on the set of FMCW parameters.

Aspect 21: The method of any of aspects 14, 15, 17, and 19, further comprising: transmitting a control message that indicates a set of FMCW parameters that are associated with the FMCW signal, the set of FMCW parameters comprising a starting frequency of the FMCW signal, a bandwidth of the FMCW signal, a slope of the FMCW signal, or any combination thereof, wherein the slope is based at least in part on the bandwidth of the FMCW signal and a duration of a symbol via which the FMCW signal is transmitted, and wherein the estimation of the OFDM channel is based at least in part on the set of FMCW parameters.

Aspect 22: The method of any of aspects 14, 15, 17, 19, and 21, further comprising: transmitting a control message comprising a trigger for the first wireless device to perform OFDM channel estimation using FMCW signals, wherein the estimation of the OFDM channel is based at least in part on the trigger, and wherein the second wireless device comprises a network entity.

Aspect 23: The method of any of aspects 14, 15, 17, 19, 21, and 22, further comprising: transmitting a control message comprising a trigger for the first wireless device to transmit a CSI report that is based at least in part on the FMCW signal; and receiving, based at least in part on the trigger, the CSI report comprising a set of CSI parameters.

Aspect 24: The method of any of aspects 14, 16, 18, and 20, further comprising: receiving a control message comprising a trigger for the second wireless device to transmit the FMCW signal, wherein transmitting the FMCW signal is based at least in part on the trigger.

Aspect 25: The method of any of aspects 14 through 24, wherein the second wireless device comprises a UE or a network entity.

Aspect 26: An apparatus for wireless communication, comprising a processor; memory coupled with the processor; and instructions stored in the memory and executable by the processor to cause the apparatus to perform a method of any of aspects 1 through 13.

Aspect 27: An apparatus for wireless communication at a first wireless device, comprising at least one means for performing a method of any of aspects 1 through 13.

Aspect 28: A non-transitory computer-readable medium storing code for wireless communication at a first wireless device, the code comprising instructions executable by a processor to perform a method of any of aspects 1 through 13.

Aspect 29: An apparatus for wireless communication, comprising a processor; memory coupled with the processor; and instructions stored in the memory and executable by the processor to cause the apparatus to perform a method of any of aspects 14 through 25.

Aspect 30: An apparatus for wireless communication at a second wireless device, comprising at least one means for performing a method of any of aspects 14 through 25.

Aspect 31: A non-transitory computer-readable medium storing code for wireless communication at a second wireless device, the code comprising instructions executable by a processor to perform a method of any of aspects 14 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communication at a first wireless device, comprising: receiving a first frequency modulated continuous waveform signal via an orthogonal frequency division multiplexing channel;
generating a second frequency modulated continuous waveform signal based at least in part on a set of frequency modulated continuous waveform parameters that are associated with the first frequency modulated continuous waveform signal; and
estimating the orthogonal frequency division multiplexing channel based at least in part on samples of a combined frequency modulated continuous waveform signal in a time domain, the combined frequency modulated continuous waveform signal comprising a combination of the first frequency modulated continuous waveform signal and the second frequency modulated continuous waveform signal.

2. The method of claim 1, wherein estimating the orthogonal frequency division multiplexing channel comprises:
filtering the combined frequency modulated continuous waveform signal; and
sampling, after the filtering, the combined frequency modulated continuous waveform signal in the time domain using a sampling rate that is based at least in part on a subband frequency range of the orthogonal frequency division multiplexing channel, wherein the estimating comprises estimating a respective value of the orthogonal frequency division multiplexing channel for each subband of a plurality of subbands in a frequency domain of the orthogonal frequency division multiplexing channel based at least in part on the sampling.

3. The method of claim 1, further comprising:
receiving one or more orthogonal frequency division multiplexing signals time division multiplexed with the first frequency modulated continuous waveform signal within the orthogonal frequency division multiplexing channel.

4. The method of claim 1, further comprising:
transmitting a capability message that indicates the first wireless device is capable of estimating the orthogonal frequency division multiplexing channel using time domain frequency modulated continuous waveform signals, wherein the first wireless device comprises a user equipment (UE).

5. (canceled)

6. The method of claim 1, further comprising:
receiving a control message that indicates whether one or more symbols of the orthogonal frequency division multiplexing channel are allocated for frequency modulated continuous waveform signals, wherein the first frequency modulated continuous waveform signal is received within a symbol of the one or more symbols that is indicated as allocated for the frequency modulated continuous waveform signals, and wherein the first wireless device comprises a user equipment (UE).

7. The method of claim 1, further comprising:
transmitting a control message that indicates whether one or more symbols of the orthogonal frequency division multiplexing channel are allocated for frequency modulated continuous waveform signals or for orthogonal frequency division multiplexing signals, wherein the first frequency modulated continuous waveform signal is received within a symbol of the one or more symbols that is allocated for the frequency modulated continuous waveform signals based at least in part on the control message, and wherein the first wireless device comprises a network entity.

8-9. (canceled)

10. The method of claim 1, further comprising:
receiving a control message comprising a trigger for the first wireless device to perform orthogonal frequency division multiplexing channel estimation using frequency modulated continuous waveform signals, wherein using the first frequency modulated continuous waveform signal and the second frequency modulated continuous waveform signal to estimate the orthogonal frequency division multiplexing channel is based at least in part on the trigger, and wherein the first wireless device comprises a user equipment (LYE).

11. (canceled)

12. The method of claim 1, further comprising:
transmitting a control message comprising a trigger for a second wireless device to transmit the first frequency modulated continuous waveform signal.

13. (canceled)

14. A method for wireless communication at a second wireless device, comprising:
generating a frequency modulated continuous waveform signal, the frequency modulated continuous waveform signal for estimation, by a first wireless device, of an orthogonal frequency division multiplexing channel;
transmitting the frequency modulated continuous waveform signal via the orthogonal frequency division multiplexing channel; and
communicating orthogonal frequency division multiplexing signals with the first wireless device via the orthogonal frequency division multiplexing channel based at least in part on the estimation of the orthogonal frequency division multiplexing channel.

15. The method of claim 14, further comprising:
transmitting one or more orthogonal frequency division multiplexing signals time division multiplexed with the frequency modulated continuous waveform signal within the orthogonal frequency division multiplexing channel.

16. The method of claim 14, further comprising:
transmitting a capability message that indicates the second wireless device is capable of transmitting frequency modulated continuous waveform signals for orthogonal frequency division multiplexing channel estimation, wherein the second wireless device comprises a user equipment (UE).

17. (canceled)

18. The method of claim 14, further comprising:
receiving a control message that indicates whether one or more symbols of the orthogonal frequency division multiplexing channel is allocated for frequency modulated continuous waveform signals, wherein the frequency modulated continuous waveform signal is transmitted within a symbol of the one or more symbols that is allocated for the frequency modulated continuous waveform signals based at least in part on the control message, and wherein the second wireless device comprises a user equipment (UE).

19. The method of claim 14, further comprising:
transmitting a control message that indicates whether one or more symbols of the orthogonal frequency division multiplexing channel are allocated for frequency modulated continuous waveform signals or for orthogonal frequency division multiplexing signals, wherein the frequency modulated continuous waveform signal is transmitted within a symbol of the one or more symbols that are allocated for the frequency modulated continuous waveform signals, and wherein the second wireless device comprises a network entity.

20. The method of claim 14, further comprising:
receiving a control message that indicates a set of frequency modulated continuous waveform parameters that are associated with the frequency modulated continuous waveform signal, the set of frequency modulated continuous waveform parameters comprising a starting frequency of the frequency modulated continuous waveform signal, a bandwidth of the frequency modulated continuous waveform signal, a slope of the frequency modulated continuous waveform signal, or any combination thereof, wherein the slope is based at least in part on the bandwidth of the frequency modulated continuous waveform signal and a duration of a symbol via which the frequency modulated continuous waveform signal is transmitted, and wherein transmitting the frequency modulated continuous waveform signal is based at least in part on the set of frequency modulated continuous waveform parameters.

21. The method of claim 14, further comprising:
transmitting a control message that indicates a set of frequency modulated continuous waveform parameters that are associated with the frequency modulated continuous waveform signal, the set of frequency modulated continuous waveform parameters comprising a starting frequency of the frequency modulated continuous waveform signal, a bandwidth of the frequency modulated continuous waveform signal, a slope of the frequency modulated continuous waveform signal, or any combination thereof, wherein the slope is based at least in part on the bandwidth of the frequency modulated continuous waveform signal and a duration of a symbol via which the frequency modulated continuous waveform signal is transmitted, and wherein the estimation of the orthogonal frequency division multiplexing channel is based at least in part on the set of frequency modulated continuous waveform parameters.

22. The method of claim 14, further comprising:
transmitting a control message comprising a trigger for the first wireless device to perform orthogonal frequency division multiplexing channel estimation using frequency modulated continuous waveform signals, wherein the estimation of the orthogonal frequency division multiplexing channel is based at least in part on the trigger, and wherein the second wireless device comprises a network entity.

23. The method of claim 14, further comprising:
transmitting a control message comprising a trigger for the first wireless device to transmit a channel state information report that is based at least in part on the frequency modulated continuous waveform signal; and
receiving, based at least in part on the trigger, the channel state information report comprising a set of channel state information parameters.

24-25. (canceled)

26. An apparatus for wireless communication, comprising:
a processor;
memory coupled with the processor; and
instructions stored in the memory and executable by the processor to cause the apparatus to:
receive a first frequency modulated continuous waveform signal via an orthogonal frequency division multiplexing channel;
generate a second frequency modulated continuous waveform signal based at least in part on a set of frequency modulated continuous waveform parameters that are associated with the first frequency modulated continuous waveform signal; and
estimate the orthogonal frequency division multiplexing channel based at least in part on samples of a combined frequency modulated continuous waveform signal in a time domain, the combined frequency modulated continuous waveform signal comprising a combination of the first frequency modulated continuous waveform signal and the second frequency modulated continuous waveform signal.

27. The apparatus of claim 26, wherein the instructions to estimate the orthogonal frequency division multiplexing channel are executable by the processor to cause the apparatus to:
filter the combined frequency modulated continuous waveform signal; and
sample, after the filtering, the combined frequency modulated continuous waveform signal in the time domain using a sampling rate that is based at least in part on a subband frequency range of the orthogonal frequency division multiplexing channel, wherein the estimating comprises estimating a respective value of the orthogonal frequency division multiplexing channel for each subband of a plurality of subbands in a frequency domain of the orthogonal frequency division multiplexing channel based at least in part on the sampling.

28. The apparatus of claim 26, wherein the instructions are further executable by the processor to cause the apparatus to:
receive one or more orthogonal frequency division multiplexing signals time division multiplexed with the first frequency modulated continuous waveform signal within the orthogonal frequency division multiplexing channel.

29-30. (canceled)
